(19) United States
(12) Patent Application Publication
(10) Pub. No.: US 2026/0330196 A1
(43) Pub. Date: Oct. 22, 2026

(54) SYSTEM

(71) Applicant: SoftBank Group Corp., Tokyo (JP)

(72) Inventor: Daisuke OGAWA, Tokyo (JP)

(73) Assignee: SoftBank Group Corp., Tokyo (JP)

(21) Appl. No.: 19/650,350

(22) Filed: Apr. 17, 2026

(30) Foreign Application Priority Data
Apr. 21, 2025 (JP) 2025-070022

(51) Int. Cl. G06N 3/0475; G06N 3/0464; G06N 5/02

(52) U.S. Cl. CPC G06N 3/0475; G06N 3/0464; G06N 5/02

(57) ABSTRACT

The present invention relates to a system that automatically and multilaterally evaluates a new idea submitted by an employee using generative AI, integrates the new idea with work performance data to calculate an overall contribution degree, visualizes an evaluation result thereof on a dashboard or the like, automatically designs an optimal reward and commendation content using the generative AI, and further automatically generates and distributes feedback and a report such as the evaluation result, an improvement proposal, a progress status, and a prediction of a business impact, thereby dramatically improving fairness, transparency, and efficiency of idea evaluation, and realizing promotion of innovation and retention of excellent human resources in an organization.

### CROSS-REFERENCE TO RELATED APPLICATION

The present application claims priority to and incorporates by reference the entire contents of Japanese Patent Application No. 2025-070022 filed in Japan on Apr. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

A problem to be solved by the present invention is a complex problem that evaluation of a new idea created by an employee in a company or an organization is influenced by subjectivity of an evaluator, human relations, dynamics in the organization, and the like, whereby an innovative idea and excellent human resources are not fairly evaluated, resulting in an outflow of a competent employee and stagnation of innovation; further, since idea evaluation and performance evaluation of normal work are separated, an overall contribution degree of the employee is not appropriately recognized, design of a reward and commendation becomes uniform and inefficient, leading to a decrease in motivation of the employee and inhibition of growth of the entire organization; and in addition, since an evaluation process, feedback, and progress reporting are dependent on individual skills and inefficient, transparency and fairness of evaluation are not ensured, communication between the employee and a supervisor becomes fragmented, and promotion of innovation and utilization of human resources in the organization cannot be sufficiently realized, and in order to solve these problems, an object of the present invention is to realize automation and standardization of idea evaluation, integrated evaluation with work performance, personalized reward design, and automation of continuous feedback and progress reporting by utilizing generative AI, and to provide a mechanism in which a creative contribution of an employee is fairly and transparently evaluated, thereby realizing promotion of innovation, retention of excellent human resources, and growth of the entire organization.

### SUMMARY OF THE INVENTION

A means for solving the problem according to the present invention is to provide an idea evaluation system operating using generative AI, the system comprising: an idea receiving unit configured to receive content of a new idea submitted by an employee, submitter information, a submission date and time, and the like, and record them in a database; an automatic evaluation index calculation unit configured to automatically calculate a plurality of evaluation indices such as innovativeness, feasibility, and economic impact of the received idea by natural language processing and knowledge base analysis using the generative AI; a work performance integration unit configured to integrate performance data regarding normal work of the employee and the evaluation indices to calculate an overall contribution degree; a visualization display unit configured to display the evaluation indices and the overall contribution degree on a dashboard in a visual format such as a graph or a table; a reward design unit configured to automatically design an optimal reward and commendation content for each employee based on the overall contribution degree using the generative AI; a feedback generation unit configured to automatically generate an evaluation result and an improvement proposal using the generative AI and present them to the employee and a supervisor; and a progress reporting unit configured to automatically report an evaluation status and progress of the idea, a prediction of an impact on work, and the like to a related party using the generative AI, wherein these units operate in cooperation with each other, thereby realizing automation and standardization of idea evaluation, integrated evaluation with work performance, personalized reward design, and automation of continuous feedback and progress reporting, and providing a mechanism in which a creative contribution of the employee is fairly and transparently evaluated.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

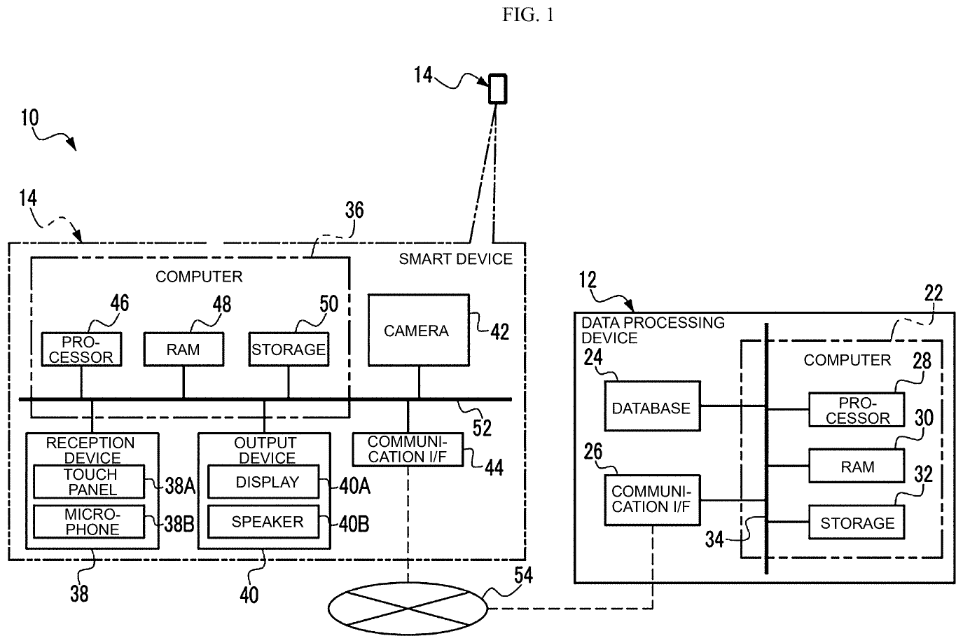

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

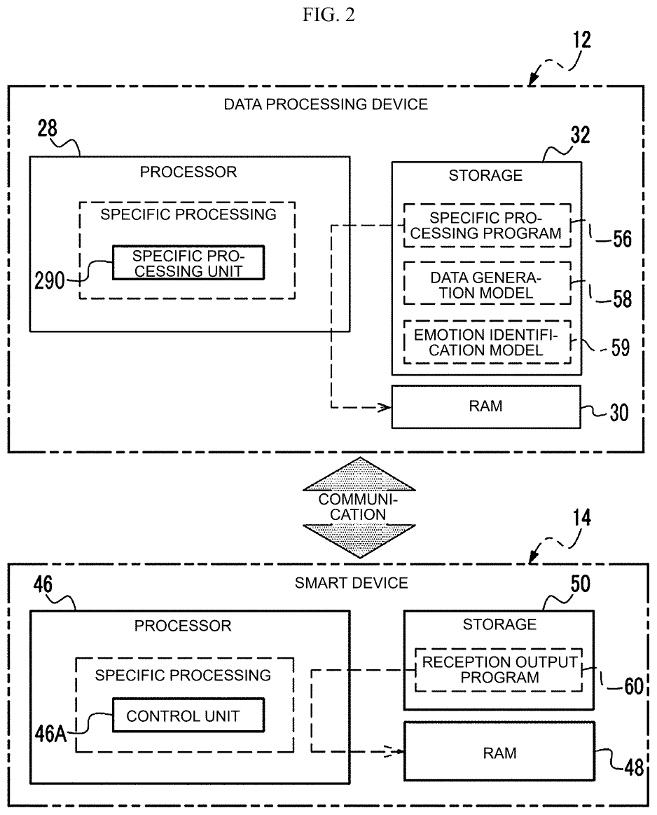

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described more specifically and in detail. Hereinafter, for each component, role sharing between a server and a terminal, a utilization method of generative AI, a specific processing example, an operational variation, an assumed application example, and the like will be comprehensively described.

First, the idea receiving unit is realized via a dedicated input screen provided on a terminal side. An employee can input a title of an idea, a detailed explanation, a related material (for example, a PDF, an image, a video, a design drawing, a reference URL, etc.), submitter information (an employee ID, an affiliated department, a job title, contact information, etc.), a submission date and time, a related project name, an expected effect and problem, and the like from a terminal such as a notebook personal computer, a tablet terminal, and a smartphone. For example, various ideas can be input regardless of field or scale, such as “proposal of an internal FAQ automatic response system by AI”, “SNS campaign planning for acquiring new customers”, and “delivery route optimization algorithm for reducing logistics costs”. Data input on the terminal side is immediately transmitted to and recorded in a database on a server side via encrypted communication. Furthermore, on the terminal side, as an input assistance function, automatic search and display of similar ideas submitted in the past, automatic saving of input content, a preview function before submission, an editing and postscript function after submission, and the like can also be implemented. Specifically, this receiving unit acquires various data transmitted from an input interface on the terminal side as structured data. This receiving unit encodes the input text data in a predetermined character code format. This receiving unit inputs image data attached as the related material to a feature extractor using a convolutional neural network. This feature extractor converts the image data into, for example, a 256-dimensional feature vector. This receiving unit transmits the structured data and the feature vector to the server via a secure communication protocol. This receiving unit deploys a lightweight natural language processing model on a memory on the terminal side as the input assistance function. This model analyzes a text stream being input by a user in real time. This model infers a probability distribution of a word appearing next. This receiving unit draws a word with the highest probability on the screen as an autocomplete candidate. Furthermore, this receiving unit converts the input text into a word embedding vector. This receiving unit calculates a cosine similarity with a vector group in a past idea database. This receiving unit extracts a past idea having a similarity exceeding a predetermined threshold, and presents the past idea on the screen as reference information. This system executes these preprocessings on the terminal side. Thereby, this system reduces communication traffic to the server side. At the same time, this system dramatically reduces a calculation load of analysis processing by a subsequent artificial intelligence model by completing normalization of the input data. This function exhibits a technical effect of reducing an input burden on the user and enabling high-quality data collection in a use case such as a patent proposal system in a manufacturing industry and a new business proposal system in an information and communication company.

The automatic evaluation index calculation unit on the server side is composed of an advanced natural language processing engine using generative AI, a knowledge base collation module, a scoring algorithm, and the like. For example, the generative AI analyzes a detailed explanatory text of the submitted idea, and performs keyword extraction, context understanding, logical structure analysis, automatic identification of related technology, and the like. The generative AI performs API linkage with various knowledge bases such as an internal past idea database, a patent database, an academic paper database, industry news, public information of competitors, and internal and external technical documents, and evaluates the innovativeness of the submitted idea from multiple angles. For example, it automatically determines “which part has novelty compared to an existing internal FAQ system”, “whether similar technology has not already spread throughout the industry”, “whether it does not overlap with a past internal proposal”, and the like. In feasibility evaluation, the generative AI also refers to internal technical resources (for example, available development personnel, budget, compatibility with existing systems, past project success rate, internal expert network, etc.), external technology trends, legal regulation information, and the like, and automatically extracts and scores conditions and risk factors necessary for realization. In economic impact evaluation, the generative AI automatically calculates various economic indices such as sales increase, cost reduction, brand value improvement, and customer satisfaction improvement using market size prediction data, internal financial results, industry average cost structure, revenue data of past similar cases, ROI simulation, and the like. For example, in the case of “SNS campaign planning”, it refers to effect data of past SNS measures and examples of competitors, and predicts an assumed reach number, an acquired customer number, cost effectiveness, and the like. These evaluation indices are automatically weighted by the generative AI and calculated as a total evaluation score. The evaluation process can also be implemented in multiple stages, such as a primary evaluation immediately after submission, a re-evaluation after a certain period, and a stage evaluation according to project progress. Specifically, this calculation unit is configured with a large language model having a self-attention mechanism as a core. This calculation unit converts the input text data into an array of integer identifiers by a tokenizer. This calculation unit adds positional encoding to the array to generate, for example, a 768-dimensional input tensor. This calculation unit inputs this input tensor to the large language model. Specific examples of the input data include a text vector indicating a difference from an existing system, time-series array data of a market size, structured data of internal resources, and the like. The large language model has weights optimized by pre-training and fine-tuning using a cross-entropy error function. The large language model non-linearly transforms the input tensor in a high-dimensional space, and infers a score from an output node corresponding to each evaluation index. Output data from the large language model is a floating-point score normalized in a range of 0.0 to 1.0, and a probability distribution of attention weights indicating a basis. Specific examples of the output data include an innovativeness score of 0.85, a feasibility score of 0.60, an economic impact score of 0.75, and the like. This calculation unit combines the output scores as a feature vector. This calculation unit inputs the combined feature vector to a multilayer perceptron to calculate a final total evaluation score. When the calculated total evaluation score exceeds a predetermined threshold, this calculation unit executes subsequent processing of assigning an automatic passing flag of a primary examination to the idea. This system realizes highly accurate determination of semantic similarity by vector calculation in a high-dimensional space. Thereby, this system exhibits a technical effect of eliminating fluctuation in subjective evaluation by humans and dramatically shortening evaluation time. This function is applied to instantly screen a huge amount of proposals in a use case such as a company-wide business improvement contest and a new theme search in a research and development department.

The work performance integration unit integrally manages various performance data regarding normal work of an employee on the server side. For example, it automatically collects various data sources such as a work evaluation score (regular evaluation by a supervisor or a colleague), a project achievement degree (delivery date compliance rate, deliverable quality, customer evaluation), attendance data (attendance rate, overtime hours, leave acquisition status), a customer satisfaction score, internal and external commendation history, and skill-up training attendance history by API linkage or batch processing. The generative AI integrates these performance data and idea evaluation indices, and calculates an overall contribution degree by weighting, for example, “idea evaluation score 70 points, work evaluation score 80 points, project achievement degree 90 points, customer satisfaction 85 points”, and the like. A weighting pattern can be customized for each organization, and is automatically adjusted according to an evaluation policy such as “innovation-oriented type” and “work stability-oriented type”, for example. Furthermore, the generative AI also learns a past contribution tendency and a growth curve of the employee, and can realize future potential evaluation, automatic extraction of a promotion candidate, and the like. Specifically, this integration unit includes a preprocessing module that maps data of heterogeneous formats to a common multidimensional vector space. This integration unit converts data collected from each system into, for example, a 128-dimensional normalized numerical vector or time-series array data indicating a performance transition over the past 12 months. This integration unit inputs these vectors and array data to a long short-term memory network or a one-dimensional convolutional neural network specialized for time-series analysis. Specific examples of the input data include a scalar value indicating a work evaluation score, a time-series array indicating an attendance status, and the like. This network extracts a hidden feature representation from the input time-series data and predicts future performance. Output data from this network is a floating-point score indicating an overall contribution degree, and a probability distribution indicating future potential. Specific examples of the output data include an overall contribution degree score of 0.88, a promotion probability of 0.82, a turnover risk of 0.05, and the like. This integration unit stores the calculated score and probability distribution in a corresponding record of the database. This integration unit executes processing of transferring these output data as an input tensor of a subsequent reward design unit. This system realizes improvement of multifaceted evaluation accuracy by normalization and integration processing of heterogeneous data. At the same time, this system exhibits a technical effect of reducing an error in future prediction through time-series analysis by a machine learning model. This function enables data-driven objective human resource evaluation in a use case such as a talent management system in a human resources department and an early discovery program for next-generation leaders.

The visualization display unit displays evaluation data and performance data aggregated on the server side on a dashboard screen on the terminal side in various formats. For example, it provides various visualization patterns such as an idea evaluation transition graph for each employee, an idea submission number ranking by department, a distribution heat map of an overall contribution degree, a radar chart by evaluation item for each idea, a project progress Gantt chart, and an innovation tendency analysis graph of the entire organization. On the terminal side, the employee himself/herself can browse his/her own evaluation status, past submission history, and feedback history, and a supervisor and an administrator can overlook the status of subordinates and the entire organization. For example, “a department with the largest number of idea submissions this month”, “an idea that obtained the highest evaluation in the past half year”, “an employee whose evaluation score rapidly increased”, and the like can be extracted and displayed with one click. Specifically, this display unit includes a dimensionality reduction engine that processes a high-dimensional evaluation vector calculated on the server side. This engine dimensionally reduces high-dimensional data into two-dimensional or three-dimensional coordinate data using a principal component analysis algorithm or a t-distributed stochastic neighbor embedding algorithm. This display unit transmits the compressed coordinate data to the terminal side in a lightweight data exchange format. This display unit directly controls a rendering pipeline of a graphics processing unit on the terminal side. This display unit dynamically draws complex graphics such as a heat map and a scatter plot based on the received coordinate data. This system adopts an architecture that separates advanced calculation processing on the server side and hardware acceleration drawing on the terminal side. Thereby, this system facilitates visual understanding of high-dimensional data. At the same time, this system exhibits a technical effect of optimizing drawing processing on the terminal side and completely preventing screen delay and freeze when displaying a large amount of data points. This function provides an intuitive data analysis environment in a use case such as a company-wide innovation portfolio monitoring dashboard for management and a resource optimal allocation simulator for department heads.

The reward design unit is realized using generative AI on the server side. The generative AI performs multivariate analysis on an overall contribution degree, a past commendation history, a motivation tendency of an employee, a reward policy of an organization, a budget status, a career orientation of the employee, a past incentive response, and the like, and automatically designs a reward and commendation content optimized for each employee. For example, it proposes a combination of various incentives according to the culture of the organization and the orientation of the employee, such as a special commendation, a monetary bonus, a stock option, a promotion recommendation, selection as a new project leader, a right to participate in overseas training, an invitation to an internal event, a right to attend skill-up training, an introduction in internal public relations, and granting of internal points. For example, for an employee who has a stronger career advancement orientation than a monetary reward in the past, a promotion recommendation and selection as a project leader are preferentially designed. A basis for reward design and an expected effect are also automatically generated as an explanatory text by the generative AI, and presented to the employee and a supervisor on the terminal side. Specifically, this design unit includes a recommendation model using a reinforcement learning algorithm based on a Markov decision process. This recommendation model defines a profile of the employee as a state space, and defines a combination of reward plans as an action space. This recommendation model sets a performance improvement rate of the employee as a reward function, and searches for an optimal policy by a Q-learning algorithm. Input data to this recommendation model is structured data such as an overall contribution degree, a motivation tendency vector, and a budget constraint matrix. Specific examples of the input data include a contribution degree score of 0.9, a career orientation category identifier of 3, a remaining budget vector, and the like. Output data from this recommendation model is a one-hot vector indicating an optimal combination of reward plans, and an expected effect score of each plan. Specific examples of the output data include a special bonus granting probability of 0.95, an overseas training recommendation probability of 0.80, and the like. This design unit decodes the output one-hot vector. This design unit generates text data of specific reward content based on the decoded information, and executes subsequent processing of transmitting the text data to the visualization display unit. This system dramatically shortens calculation time of a huge combinatorial optimization problem. Thereby, this system exhibits a technical effect of dynamically presenting a reward perfectly matching an individual orientation and maximizing a motivation improvement effect of the employee. This function is applied in a use case such as a personalized human resource system in a global company promoting diverse work styles and a startup company requiring flexible incentive design.

The feedback generation unit automatically generates an evaluation result and an improvement proposal using generative AI on the server side. For example, when the innovativeness of an idea is high but the feasibility is low, it presents a specific action plan such as “recommending cooperation with an internal expert to solve a technical problem” and “expecting improvement in feasibility by conducting additional market research”. Conversely, when the feasibility is high but the economic impact is limited, it generates practical advice such as “considering collaboration with another department to maximize a cost reduction effect” and “recommending pilot introduction as an additional proposal to an existing customer”. Feedback is distributed to an employee and a supervisor through a plurality of channels such as a dashboard on the terminal side, an email notification, and chatbot linkage. Furthermore, the feedback content also learns past responses and improvement history of the employee, and evolves into more personalized content. Specifically, this generation unit includes a text generation model adopting a decoder-only transformer architecture. This generation model is fine-tuned in advance using an excellent internal feedback case dataset. Input data to this generation model is an evaluation score vector, a text embedding vector of a past feedback history, and a flag array indicating an improvement point. Specific examples of the input data include an innovativeness score of 0.8, a feasibility score of 0.5, a past pointed-out matter vector, and the like. This generation model searches for a contextually most natural and effective word sequence using a beam search algorithm, and constructs a sentence. Output data from this generation model is a feedback text in natural language, and a category identifier of an action plan. Specific examples of the output data include a text sentence recommending implementation of market research, a technical cooperation category identifier of 2, and the like. This generation unit asynchronously push-distributes the generated text to a notification module on the terminal side. This generation unit executes subsequent processing of automatically adding contact information of a related department and a link to a reference document based on the output category identifier. This system instantly and automatically generates personalized high-quality feedback. Thereby, this system significantly reduces communication costs of managers. At the same time, this system exhibits a technical effect of equalizing the quality of proposals by highly accurate sentence generation along a context by natural language processing. This function contributes to efficiency of guidance work in a use case such as automation support of code review in a large-scale development organization and an automatic correction system of a proposal document in a sales department.

The progress reporting unit analyzes an evaluation status and progress of an idea, a prediction of an impact on work, and the like using generative AI on the server side, and automatically generates a report viewable by all related parties in real time. For example, it generates a detailed report including progress and an impact prediction, such as “a new service proposal is currently in a demonstration experiment stage, and a sales increase effect is expected in an initial evaluation” and “a business process automation plan requires additional consideration because a technical problem remains”, and distributes the report to a related party via a dashboard on the terminal side, an email notification, or the like. Furthermore, the generative AI analyzes past evaluation data and results, and automatically calculates a prediction of a business impact of the idea, a contribution degree to future organizational growth, and the like, and also presents a specific numerical prediction, such as “if this idea is realized, an annual cost reduction of 10% is expected” and “the number of new customers acquired may increase by 20%”. Specifically, this reporting unit includes a prediction engine using a graph neural network. This prediction engine models a complex dependency relationship between projects as a graph structure of nodes and edges. Input data to this prediction engine is a time-series tensor indicating a progress status of a project, and completion result data of a past similar project. Specific examples of the input data include an array of the number of completed tasks in the past four weeks, an operation rate vector of members, and the like. This prediction engine executes a graph convolution operation, and predicts a future numerical value using a regression model while updating a feature amount of each node. Output data from this prediction engine is a probability distribution of a scheduled completion date, a continuous value indicating a predicted value of a cost reduction amount, and structured data for report configuration. Specific examples of the output data include a scheduled date exceeding probability of 0.15, a predicted cost reduction amount of 1.5 million yen, and the like. This reporting unit pours the output predicted value and structured data into a predetermined template engine. This reporting unit dynamically renders an interactive report in a hypertext markup language format, and executes subsequent processing of distributing the report to a terminal of a related party. This system dramatically improves progress prediction accuracy of a project having a complex dependency relationship. Thereby, this system realizes speeding up of decision making by real-time data update. At the same time, this system exhibits a technical effect of completely automating report creation work and reducing human-hours. This function provides an objective future prediction based on data in a use case such as a program management office supervising a plurality of agile development teams and monitoring of return on investment in a corporate planning department.

Also, for example, immediately after an employee submits an idea from a terminal, generative AI immediately performs a primary evaluation and returns a provisional score and simple feedback, whereby motivation of the employee can be maintained. For example, the generative AI is also in charge of scheduling a regular review session, and can automatically adjust schedules of the employee and a supervisor and automatically register them in a calendar on the terminal side. For example, the generative AI can also execute meta-analysis on the server side, such as analyzing an innovation tendency of the entire organization and analyzing in which department idea creation is active and which type of idea easily obtains a high evaluation, and present it as a report to an administrator on the terminal side. For example, when an employee submits a plurality of ideas, a mechanism in which each evaluation transition and feedback history are visualized in chronological order and the employee himself/herself can realize self-growth can also be implemented. Specifically, this system arranges a lightweight neural network model dedicated to inference on an edge server or an in-memory cache in order to realize immediate evaluation. This evaluation module executes vectorization of input text and inner product calculation with a learned weight matrix in units of milliseconds, and immediately returns a score. This system applies a constraint satisfaction problem solving algorithm in a scheduling function. This algorithm receives a free time matrix of a plurality of persons as an input, and extracts an optimal solution satisfying constraint conditions such as availability of a conference room and priority from a search space at high speed. This system executes a non-hierarchical clustering algorithm such as a K-means method in a meta-analysis function. This algorithm groups feature vectors of ideas that obtained high evaluations in a high-dimensional space, and automatically extracts a common trend and keyword. This system executes these processings in parallel. Thereby, this system realizes load reduction of a main server by decentralization of inference processing. At the same time, this system exhibits a technical effect of reducing a calculation amount of schedule adjustment by an optimization algorithm and improving responsiveness of the entire system. This function minimizes an operation cost in a use case such as operation of an ideathon event in a large company having tens of thousands of employees and automatic setting of a daily one-on-one meeting.

Furthermore, for example, in order to cope with an internal multilingual environment, generative AI automatically translates a submitted idea and feedback, and can smoothly perform idea sharing and evaluation among global bases. For example, when it is desired to ensure anonymity of an employee, a function in which the generative AI masks submitter information and eliminates bias during evaluation can also be implemented. For example, when an external expert or customer is allowed to participate in an evaluation process, the generative AI can automatically adjust an evaluation criterion and feedback content, and provide an interface for an external evaluator to the terminal side. Specifically, this system implements an encoder and decoder type neural machine translation model for multilingual support. This translation module maps input text of an arbitrary language to a common latent space vector. This translation module decodes the vector into text of a designated target language. This system operates a named entity recognition model in an anonymization processing unit. This anonymization processing unit identifies a token indicating a personal name, a department name, a project name, and the like in the text. This anonymization processing unit executes preprocessing of replacing the identified token with a specific masking symbol, and completely eliminates personally identifiable information before input to an evaluation model. This system provides an application programming interface for transmitting and receiving data to and from an external system in an external linkage unit. This linkage unit executes mapping processing of automatically converting received external structured data into an internal data schema. This system executes these advanced preprocessing and conversion processing in a pipelined manner. Thereby, this system enables data integration across language barriers, and dramatically expands a learning dataset of a machine learning model. At the same time, this system exhibits a technical effect of maintaining inference accuracy of machine learning while satisfying a requirement of personal information protection. This function realizes secure and seamless information distribution in a use case such as a knowledge sharing platform in a global research and development department of a multinational company and an inter-company collaboration system promoting open innovation.

As described above, the embodiment of the present invention intensively and multi-purposely utilizes generative AI on a server side to automate and sophisticate all processes such as natural language processing, knowledge base collation, data analysis, scoring, reward design, feedback generation, progress reporting, scheduling, meta-analysis, multilingual support, anonymization, and external linkage, while providing a multifunctional user interface on a terminal side that allows an employee and a manager to intuitively input, browse, and confirm information in real time, thereby making it possible to dramatically improve fairness, transparency, and efficiency of idea evaluation and maximize innovation promotion and human resource utilization of an organization. Specifically, the present system integrates a plurality of specialized neural network models as a microservice architecture. The integrated architecture constructs a data pipeline between respective modules via an asynchronous messaging queue. The present system implements processing on the terminal side as a single page application using a virtual document object model. The application minimizes the number of times of communication with a server, and asynchronously acquires only necessary difference data to update a screen. The present system dramatically improves scalability and fault tolerance of the entire system by these architecture designs. At the same time, the present system exhibits a technical effect of reducing consumption of a network bandwidth and maximizing throughput by large-scale parallel processing. This function provides stable performance and high availability in a use case such as construction of a large-scale enterprise system in a cloud-native environment or a company-wide campaign platform where a traffic spike is expected, for example.

### System Configuration

The system according to the present embodiment comprises an idea receiving unit, an automatic evaluation index calculation unit, a work performance integration unit, a visualization display unit, a reward design unit, a feedback generation unit, a progress reporting unit, a database management unit, a user authentication unit, and an external linkage unit.

The idea receiving unit provides an input interface for an employee to submit a new idea from a terminal, and receives various data such as a title of the idea, a detailed explanation, a related material (a PDF, an image, a video, a design drawing, a reference URL, etc.), submitter information (an employee ID, an affiliated department, a job title, contact information, etc.), a submission date and time, a related project name, an expected effect and problem, and reference external information from, for example, a notebook computer, a tablet terminal, a smartphone, or the like. For example, when the employee inputs “proposal of an internal FAQ automatic response system by AI”, “SNS campaign planning for acquiring a new customer”, “delivery route optimization algorithm for reducing a logistics cost”, or the like, a related drawing, a market research material, an example of a competitor, and the like can also be attached, and the receiving unit transmits and records these data to a database management unit on a server side by encrypted communication. Furthermore, the receiving unit also realizes, as an input assistance function, automatic search and display of a similar idea submitted in the past, automatic saving of input content, a preview before submission, editing and postscript after submission, version management of submitted content, automatic tagging at the time of submission, and the like. Specifically, the receiving unit includes an input processing module, and acquires text data in a predetermined encoding format. The receiving unit executes preprocessing of converting attached image data into a feature map using a convolutional neural network. The receiving unit establishes a secure communication channel using a transport layer security protocol. The receiving unit exchanges a session key by a public key cryptography method, encrypts data, and transmits the data. The receiving unit inputs a text stream being input to a recurrent neural network in real time as the input assistance function. The network holds a hidden state of a past input sequence and outputs an appearance probability distribution of a next word. The receiving unit presents a word string having the highest probability as an autocomplete candidate. The present system executes efficient initial processing of multimodal data. Thereby, the present system significantly reduces a calculation load in an analysis module in a subsequent stage. At the same time, the present system exhibits a technical effect of realizing falsification prevention and ensuring of confidentiality by secure data transfer. This function provides a safe and efficient data input environment in a use case such as an internal collection system for highly confidential unpublished patent information or a new product planning database requiring strict access control, for example.

The automatic evaluation index calculation unit is realized using generative AI on the server side, analyzes a detailed explanatory text and an attached material of the submitted idea, and automatically calculates a plurality of evaluation indices such as innovativeness, feasibility, and economic impact. For example, the generative AI extracts a gist and a feature of the idea using natural language processing technology, collates them with internal and external knowledge bases, a patent database, an academic paper database, industry news, public information of a competitor, a past internal idea case, and the like, and determines a difference from existing technology and novelty. For example, it automatically determines “which part has novelty compared to an existing internal FAQ system”, “whether similar technology has not already spread in the entire industry”, “whether it does not overlap with a past internal proposal”, and the like. In feasibility evaluation, it refers to an internal technical resource, a past project success rate, a failure case, an internal expert network, an external technology trend, legal regulation information, and the like, and extracts and scores a condition and a risk factor necessary for realization. In economic impact evaluation, it automatically calculates an economic index such as sales increase, cost reduction, brand value improvement, and customer satisfaction improvement using market size prediction data, an internal financial result, an industry average cost structure, revenue data of a past similar case, ROI simulation, and the like. For example, in the case of “SNS campaign planning”, it refers to effect data of a past SNS measure and an example of a competitor, and predicts an assumed reach number, an acquired customer number, cost effectiveness, and the like. The automatic evaluation index calculation unit automatically performs weighting on these evaluation indices to calculate a total evaluation score. As a specific example of a prompt text to be read by the generative AI, “Analyze the following idea explanatory text, evaluate it on a 10-point scale from three viewpoints of innovativeness, feasibility, and economic impact, and calculate a total evaluation score together with a basis for each viewpoint. Idea explanatory text: ‘Proposal of an internal FAQ automatic response system by AI. For a complex inquiry that cannot be handled by an existing FAQ system, automatic response accuracy is improved by utilizing natural language processing technology.’” and the like can be cited. Specifically, the calculation unit includes a large language model having tens of billions of parameters as an evaluation engine. The calculation unit converts text data including the prompt text into an array of integer identifiers by a tokenizer. The calculation unit adds positional encoding to the array to generate an input tensor. Specific examples of input data include an instruction prompt vector to evaluate innovativeness, a word embedding vector of an idea text, and the like. The large language model calculates a dependency relationship between long-distance words in the input text in parallel by a self-attention mechanism. Output data from the large language model is a continuous value score in a range of 0 to 1 output from an output node corresponding to each evaluation viewpoint via a sigmoid function, and a token probability distribution for generating a text serving as a basis. Specific examples of the output data include an innovativeness score of 0.85, a feasibility score of 0.55, and the like. The calculation unit multiplies the output score vector by a predetermined weight matrix to calculate the total evaluation score. When the score is less than a threshold value, the calculation unit executes subsequent processing of setting a flag prompting reconsideration. The present system ensures objectivity of evaluation by mathematical modeling of a complex context. Thereby, the present system exhibits a technical effect of enabling instantaneous collation with a huge amount of external data that cannot be processed by a human, and dramatically improving evaluation accuracy. This function realizes efficiency improvement and sophistication of examination work in a use case such as initial screening of an investment project in a venture capital or an automatic examination system for a subsidy application in a public institution, for example.

The work performance integration unit integrally manages various performance data regarding normal work of an employee on the server side, and integrates the performance data with the evaluation indices to calculate an overall contribution degree. For example, it automatically collects various data sources such as a work evaluation score (regular evaluation by a supervisor or a colleague), a project achievement degree (delivery date compliance rate, deliverable quality, customer evaluation), attendance data (attendance rate, overtime hours, leave acquisition status), a customer satisfaction score, internal and external past commendation history, and a skill-up training attendance history by API linkage or batch processing. For example, it performs weighting on a plurality of data to calculate an integrated score, such as “when an employee A obtains a high evaluation in a new service proposal and also shows high performance in normal work, an overall contribution degree is calculated to be high” and “since an employee B has a high idea evaluation score but a low work evaluation score, an overall contribution degree becomes medium”. A weighting pattern is customizable for each organization, and is automatically adjusted according to an evaluation policy such as an “innovation-oriented type” or a “work stability-oriented type”, for example. Furthermore, it also learns a past contribution tendency and a growth curve of the employee, and can realize future potential evaluation, automatic extraction of a promotion candidate, and the like. Specifically, the integration unit includes a scoring engine using a gradient boosting decision tree algorithm or a multilayer perceptron. The scoring engine maps data in heterogeneous formats collected from respective systems to a common multidimensional vector space. Specific examples of input data include a scalar value indicating a work evaluation score, a time-series array indicating an attendance status, and the like. The scoring engine learns an interaction of nonlinear feature amounts, and dynamically optimizes a weight of each input feature amount. Output data from the scoring engine is a normalized score value indicating the overall contribution degree, and an importance vector indicating a contribution degree of each input feature amount. Specific examples of the output data include an overall contribution degree of 0.88, a contribution degree of a project achievement degree of 0.45, and the like. The integration unit executes subsequent processing of updating and writing the calculated score to a corresponding record in an employee profile database. The present system realizes standardization of evaluation indices by normalization and integration of heterogeneous data. Thereby, the present system exhibits a technical effect of enabling discovery of a hidden correlation by a machine learning model and improving prediction accuracy. This function supports a strategic personnel measure based on data in a use case such as an optimal personnel allocation simulation in a large-scale organization or an early detection system for a turnover risk, for example.

The visualization display unit displays evaluation data and performance data aggregated on the server side on a dashboard screen on the terminal side in various formats. For example, it provides various visualization patterns such as an idea evaluation transition graph for each employee, an idea submission number ranking by department, a distribution heat map of an overall contribution degree, a radar chart by evaluation item for each idea, a project progress Gantt chart, and an innovation tendency analysis graph of the entire organization. For example, “a department with the largest number of idea submissions this month”, “an idea that obtained the highest evaluation in the past half year”, “an employee whose evaluation score rapidly increased”, and the like can be extracted and displayed with one click. On the terminal side, the employee himself/herself can browse his/her own evaluation status, past submission history, and feedback history, and a supervisor and a manager can have a bird's-eye view of a status of a subordinate and the entire organization. Specifically, the display unit includes a rendering engine that processes multidimensional data aggregated on the server side. The rendering engine projects high-dimensional data onto a low-dimensional space using a dimensionality reduction algorithm based on manifold learning. The rendering engine generates two-dimensional or three-dimensional coordinate data while maintaining a local clustering structure of the data. The display unit transmits the generated coordinate data to the terminal in a lightweight data description language format. The display unit drives a web graphics library on the terminal side. The display unit utilizes hardware acceleration to draw a scatter plot and a heat map including tens of thousands of data points at a high speed of 60 frames per second. The present system optimally distributes a calculation resource on the server side and a drawing resource on the terminal side. Thereby, the present system improves a response speed of the entire system. At the same time, the present system exhibits a technical effect of promoting intuitive understanding of a complex data structure. This function provides an interactive data operation experience in a use case such as an exploratory data analysis tool for a data scientist or a real-time performance monitoring dashboard in a management meeting, for example.

The reward design unit performs multivariate analysis on the overall contribution degree, past commendation history, motivation tendency of the employee, reward policy of the organization, budget status, career orientation of the employee, past incentive response, and the like using the generative AI on the server side, and automatically designs a reward and commendation content optimized for each employee. For example, it proposes a combination of various incentives according to a culture of the organization and an orientation of the employee, such as a special commendation, a monetary bonus, a stock option, a promotion recommendation, selection as a new project leader, a right to participate in overseas training, an invitation to an internal event, a right to attend skill-up training, an introduction in internal public relations, and granting of internal points. For example, the generative AI also automatically generates a basis for reward design and an expected effect as an explanatory text, such as “for an employee who has a stronger career advancement orientation than a monetary reward in the past, a promotion recommendation and selection as a new project leader are preferentially designed” and “when selecting a new project leader, past leader experience and a project success rate are also taken into consideration”, and presents them to the employee and the supervisor on the terminal side. As a specific example of a prompt text to be read by the generative AI, “Consider an overall contribution degree, past commendation history, motivation tendency, and reward policy of an organization of an employee X, and design an optimal reward and commendation plan. Explain proposal content together with a basis.” and the like can be cited. Specifically, the design unit includes an optimization module using a reinforcement learning model based on a Markov decision process. Input data to the optimization module is an overall contribution degree score of the employee, a past reward history vector, and a scalar value indicating a budget upper limit. Specific examples of the input data include a contribution degree score of 0.92, a budget upper limit of 1 million yen, and the like. The reinforcement learning model defines a state space as an employee profile and an action space as a combination of reward plans. The reinforcement learning model defines a reward function as a performance improvement rate of the employee, and optimizes a policy by a Q-learning algorithm. Output data from the reinforcement learning model is a probability distribution vector indicating an optimal combination of reward plans, and text data of a proposal reason by a generative model. Specific examples of the output data include a promotion recommendation probability of 0.90, a special bonus probability of 0.10, and the like. The design unit selects a plan having the highest expected value from the output probability distribution. The design unit executes subsequent processing of calling an application programming interface of a personnel system and automatically issuing an approval workflow. The present system solves a total optimization problem under a budget constraint at a high speed. Thereby, the present system exhibits a technical effect of ensuring fairness and transparency of reward allocation by a data-driven approach. This function realizes a highly convincing evaluation system in a use case such as an automatic incentive calculation system in a sales organization introducing a performance-based system or a dynamic reward presentation platform for a freelance engineer, for example.

The feedback generation unit automatically generates an evaluation result and an improvement proposal using the generative AI on the server side. For example, when innovativeness of an idea is high but feasibility is low, it presents a specific action plan such as “recommending cooperation with an internal expert to solve a technical problem” and “expecting improvement in feasibility by conducting an additional market research”. Conversely, when feasibility is high but an economic impact is limited, it generates practical advice such as “considering collaboration with another department to maximize a cost reduction effect” and “recommending pilot introduction as an additional proposal to an existing customer”. Feedback is distributed to the employee and the supervisor through a plurality of channels such as a dashboard on the terminal side, an email notification, and chatbot linkage. Furthermore, feedback content also learns a past response and an improvement history of the employee, and evolves into more personalized content. As a specific example of a prompt text to be read by the generative AI, “Generate a specific improvement proposal and a future action plan for an employee based on the following evaluation result. Evaluation result: innovativeness 8 points, feasibility 5 points, economic impact 7 points.” and the like can be cited. Specifically, the generation unit includes a language generation model based on a pre-trained transformer decoder model. The language generation model is fine-tuned using an excellent internal feedback case dataset. Input data to the language generation model is a numerical vector of an evaluation score and matrix data of an attention weight output from an evaluation model. Specific examples of the input data include an innovativeness score of 0.8, a feasibility score of 0.5, and the like. The language generation model calculates an appearance probability of a word according to a context based on the input vector and matrix data, and generates a sentence. Output data from the language generation model is text data in a natural language including an improvement proposal, and a list of uniform resource locators of related internal documents. Specific examples of the output data include a text proposing implementation of a market research, a link to a related past success case, and the like. The generation unit checks an inappropriate expression in the generated text by a rule-based filtering module. The generation unit executes subsequent processing of asynchronously push-transmitting the text that has passed the check to a display area on the terminal side. The present system dramatically reduces a work load of a manager by automatic generation of high-quality feedback. At the same time, the present system exhibits a technical effect of equalizing quality of a proposal by a model that has learned a past success pattern. This function constructs a scalable guidance system in a use case such as an automatic correction system for a learner in an online education platform or advice generation for improving response quality in a customer support department, for example.

The progress reporting unit analyzes an evaluation status and progress of an idea, a prediction of an impact on work, and the like using the generative AI on the server side, and automatically generates a report viewable by all related parties in real time. For example, it generates a detailed report including progress and an impact prediction, such as “a new service proposal is currently in a demonstration experiment stage, and a sales increase effect is expected in an initial evaluation” and “a business process automation plan requires additional consideration because a technical problem remains”, and distributes the report to a related party by a dashboard on the terminal side, an email notification, or the like. Furthermore, the generative AI analyzes past evaluation data and a track record, automatically calculates a prediction of a business impact of the idea, a contribution degree to future organizational growth, and the like, and also presents a specific numerical prediction, such as “if this idea is realized, a 10% annual cost reduction is expected” and “the number of new customer acquisitions may increase by 20%”, for example. As a specific example of a prompt text to be read by the generative AI, “Predict a future business impact based on a progress status and an evaluation history of the following idea, and generate a progress report for a related party.” and the like can be cited. Specifically, the reporting unit includes a predictive analysis model using an autoregressive time-series prediction model. Input data to the predictive analysis model is time-series data of a task digestion rate acquired from a project management tool, and matrix data of a resource operation rate. Specific examples of the input data include an array of the number of completed tasks in the past four weeks, an operation rate vector of a member, and the like. The predictive analysis model learns a past time-series pattern and extrapolates a future numerical value. Output data from the predictive analysis model is a continuous value from 0 to 1 indicating a target achievement probability at a specific point in time in the future, and an identifier list of a predicted bottleneck task. Specific examples of the output data include a release probability of 0.75 after three months, a task identifier 402 with a high delay risk, and the like. The reporting unit combines a prediction result and a generated explanatory text. The reporting unit executes subsequent processing of dynamically generating a report file in a portable document format format or an interactive hypertext markup language format, and saving the report file in a storage area of the related party. The present system enables early discovery of a project delay risk by objective future prediction based on data. At the same time, the present system exhibits a technical effect of completely automating report creation work and significantly reducing man-hours. This function realizes proactive risk management in a use case such as automation of progress management in a large-scale system integration project or generation of a prediction report of an inventory depletion risk in supply chain management, for example.

A database management unit centrally manages all idea data, evaluation data, performance data, reward history, feedback history, progress data, user information, and the like on a server side, and is responsible for data consistency, security, backup, access authority management, and the like. For example, it manages all past idea submission histories in chronological order, and analyzes a submission tendency for each employee and an innovation tendency of the entire organization. A user authentication unit performs user authentication using an employee ID, a password, biometric authentication, two-factor authentication, or the like at the time of access from a terminal, and controls a data range that can be browsed and edited according to an access authority. For example, a general employee can browse only his/her own submitted data, a supervisor can also browse data of a subordinate, and an administrator can access all data. An external linkage unit links with an external knowledge base, a market database, an industry news API, an external evaluator interface, an external reward service, an external personnel system, and the like to ensure expandability and flexibility of the system. For example, when an external expert or customer participates in an evaluation process, it provides an interface for an external evaluator and automatically adjusts an evaluation criterion and feedback content. Specifically, the database management unit adopts a polyglot persistence architecture combining a relational database and a non-relational database. The database management unit stores time-series data in a column-oriented database to improve an execution speed of an aggregation query. The authentication unit implements a stateless authentication mechanism using an open authorization protocol and a web token. The authentication unit hashes and stores biometric authentication data, and executes a secure collation process. The linkage unit performs high-speed binary communication with an external system using a remote procedure call protocol. The linkage unit executes serialization and deserialization of data using a protocol buffer. The system eliminates an input/output bottleneck by selecting a data store in the right place. Thereby, the system facilitates scale-out of a server by stateless authentication. At the same time, the system exhibits a technical effect of minimizing network overhead by binary communication. This function provides a robust and scalable foundation in a use case such as a consumer web service having millions of users or a financial transaction system requiring a response in milliseconds, for example.

As described above, in the system according to the present embodiment, the respective units cooperate to comprehensively and efficiently realize a series of processes for maximizing innovation promotion and human resource utilization, such as various idea submissions by an employee, advanced automatic evaluation by generative AI, integration with work performance, visualization, optimal reward design, specific feedback generation, progress reporting, data management, user authentication, and external linkage. A prompt sentence to be read by the generative AI is optimized for each step such as evaluation, reward design, feedback, and progress reporting, and various prompt sentences are prepared for each application, such as “Evaluate the innovativeness of this idea in comparison with an industry standard”, “Propose an optimal incentive based on the contribution degree of employee X”, “Present a specific improvement measure based on the evaluation result”, and “Predict a future business impact based on progress data and create a report”, for example. Specifically, the system integrally controls a plurality of neural network modules having a large language model as a core. The control unit converts input text data into a 512-dimensional word embedding vector. The control unit inputs this vector to a transformer model equipped with a self-attention mechanism. The transformer model calculates a dependency relationship between respective elements of the input vector. The transformer model outputs a hidden state tensor subjected to context weighting. The system inputs this hidden state tensor to a subsequent task-specific multilayer perceptron. The multilayer perceptron outputs an evaluation score and a classification label. The system passes these output results to a threshold determination module. The threshold determination module triggers a subsequent reward design process only when the score exceeds a predetermined threshold. The system also adopts a dynamic template synthesis algorithm in generating the prompt sentence. The algorithm acquires attribute data of the employee and a past evaluation history as structured data. The algorithm converts this structured data into a natural language prompt character string. The system inputs this dynamic prompt to the large language model. The large language model generates a response text optimized for the context. The system extracts a specific numerical value and an action plan from this response text using a regular expression. The system stores the extracted data in a relational database. The system realizes an objective and high-speed evaluation process independent of human subjectivity by the above series of processes. The system eliminates variation in evaluation and significantly shortens a processing time compared to conventional manual work. The system is applicable to various use cases such as automatic evaluation of a business improvement proposal in a manufacturing industry and feedback generation of a new project in an IT company.

### Implementation Steps

Step 1: Idea Submission/Receiving An employee uses a dedicated input screen of a terminal to input a title of a new idea, a detailed explanation, a related material (PDF, image, video, design drawing, reference URL, etc.), submitter information (employee ID, affiliated department, job title, contact information, etc.), a submission date and time, a related project name, an expected effect and problem, and the like. For example, various ideas such as “Proposal of an internal FAQ automatic response system by AI”, “SNS campaign planning for acquiring a new customer”, and “Delivery route optimization algorithm for reducing a logistics cost” are targeted. Data input on the terminal side is transmitted to and recorded in a database on a server side by encrypted communication, and automatic search and display of a past similar idea, a preview before submission, editing and postscript after submission, version management, automatic tagging at the time of submission, and the like are also realized as an input assistance function. Specifically, the receiving module passes input unstructured text data to a natural language processing pipeline. The pipeline performs morphological analysis on the text to generate a token sequence. The pipeline removes a stop word from the token sequence. The pipeline converts the remaining tokens into a feature amount vector using a TF-IDF algorithm. The receiving module inputs attached image data to a convolutional neural network. The convolutional neural network extracts an edge and texture feature from the image and outputs a 256-dimensional image feature vector. The receiving module combines the text feature amount vector and the image feature vector to generate a multimodal feature tensor. The receiving module inputs this multimodal feature tensor to a cosine similarity calculation module. The calculation module calculates a similarity score with a past idea feature tensor group in the database. The calculation module extracts a past idea having a similarity score of 0.85 or more. The receiving module displays this extraction result on a screen of the terminal in real time. The system uses a support vector machine classifier in an automatic tagging function. The classifier receives the multimodal feature tensor as an input. The classifier outputs a probability distribution indicating a technical field and a business category. The system automatically assigns a category having the maximum probability as a tag. The system realizes structuring of input data and speeding up of search by the above series of processes. The system prevents a duplicate proposal in advance and improves storage efficiency of the database. The system is applied to a prior art search for a patent idea in a research and development department, a duplication check for a new plan in a sales department, and the like.

Step 2: Automatic Evaluation Index Calculation by Generative AI An automatic evaluation index calculation unit on the server side inputs a detailed explanatory text and an attached material of the submitted idea to generative AI, and automatically calculates a plurality of evaluation indices such as innovativeness, feasibility, and economic impact. The generative AI extracts a gist and a feature of the idea using natural language processing technology, collates them with internal and external knowledge bases, a patent database, an academic paper database, industry news, public information of a competitor, a past idea case in the company, and the like, and determines a difference from existing technology and novelty. In feasibility evaluation, it refers to internal technical resources, a past project success rate, a failure case, an internal expert network, an external technology trend, legal regulation information, and the like, and extracts and scores a condition and a risk factor necessary for realization. In economic impact evaluation, it automatically calculates an economic index such as sales increase, cost reduction, brand value improvement, and customer satisfaction improvement using market size prediction data, internal financial results, an industry average cost structure, revenue data of a past similar case, ROI simulation, and the like. As a specific example of a prompt sentence to be read by the generative AI, “Analyze the following idea explanatory text, evaluate it on a 10-point scale from three viewpoints of innovativeness, feasibility, and economic impact, and calculate a total evaluation score together with a basis for each viewpoint. Idea explanatory text: ‘Proposal of an internal FAQ automatic response system by AI. For a complex inquiry that cannot be handled by an existing FAQ system, automatic response accuracy is improved by utilizing natural language processing technology.’” and the like can be cited. Specifically, the calculation unit drives a dedicated evaluation neural network obtained by fine-tuning a large language model. The calculation unit encodes the idea explanatory text into a 1024-dimensional input tensor. The calculation unit supplies this input tensor to an input layer of the evaluation neural network. The evaluation neural network calculates a semantic distance between keywords in the input tensor through a multi-layer self-attention mechanism. The evaluation neural network calculates an inner product of an embedding vector group of related literature acquired from an external database and the input tensor. The evaluation neural network calculates a novelty score based on this inner product value. The evaluation neural network uses a gradient boosting decision tree model that receives past project data as an input in combination to evaluate feasibility. The decision tree model receives a numerical vector such as a project budget and period as an input. The decision tree model outputs a continuous value between 0 and 1 indicating a success probability. The calculation unit executes a Monte Carlo simulation engine to evaluate an economic impact. The engine receives a probability distribution of a market growth rate and a cost reduction rate as an input. The engine performs 10,000 trials and outputs distribution data of expected revenue. The calculation unit normalizes these output scores to generate a total evaluation vector. The calculation unit passes this total evaluation vector to a subsequent ranking processing module. The system realizes an objective and quantitative evaluation exceeding a human cognitive limit by calculation in these high-dimensional spaces. The system dramatically improves evaluation accuracy and contributes to maximization of return on investment. The system is applied to automatic screening of an investment project in a venture capital, a feasibility study of a new business proposal in a manufacturing industry, and the like.

Step 3: Work Performance Data Integration A work performance integration unit on the server side integrally manages various performance data regarding normal work of an employee, and integrates the performance data with an evaluation index to calculate an overall contribution degree. It automatically collects various data sources such as a work evaluation score (regular evaluation by a supervisor or a colleague), a project achievement degree (delivery date compliance rate, deliverable quality, customer evaluation), attendance data (attendance rate, overtime hours, leave acquisition status), a customer satisfaction score, internal and external commendation histories, and a skill-up training attendance history by API linkage or batch processing. For example, it calculates an integrated score by weighting a plurality of data, such as “when employee A obtains a high evaluation in a new service proposal and also shows high performance in normal work, the overall contribution degree is calculated to be high” and “since employee B has a high idea evaluation score but a low work evaluation score, the overall contribution degree is medium”. Specifically, the integration unit normalizes data collected from heterogeneous data sources to construct a single performance feature vector. The integration unit scales numerical data such as a work evaluation score and attendance data to a range of 0 to 1. The integration unit converts categorical data such as a commendation history and a training attendance history into a binary vector by one-hot encoding. The integration unit combines these vectors to generate a 256-dimensional performance feature vector. The integration unit combines this performance feature vector and the idea total evaluation vector calculated in the preceding stage. The integration unit inputs this combined vector to an integrated evaluation model composed of a multilayer perceptron. The integrated evaluation model has three hidden layers, and a ReLU activation function is applied to each layer. The integrated evaluation model learns a non-linear interaction of each feature amount in the input vector. The integrated evaluation model outputs an overall contribution degree score in a range of 0 to 100 from a final output layer. The integrated evaluation model simultaneously outputs an attention weight vector indicating a degree of influence given to the total score by each feature amount. The integration unit transmits this overall contribution degree score to a subsequent reward design module. The integration unit transmits this attention weight vector to a visualization module and presents it as a basis for evaluation. The system models a complex evaluation structure that cannot be captured by simple linear addition by the above series of processes. The system improves fairness and transparency of evaluation and contributes to improvement of employee motivation. The system is applied to automatic discovery of a next-generation leader in a personnel department, optimal allocation of an incentive in a sales department, and the like.

Step 4: Visualization of Evaluation and Contribution Degree A visualization display unit on the server side displays aggregated evaluation data and performance data on a dashboard screen on the terminal side in various formats. It provides various visualization patterns such as an idea evaluation transition graph for each employee, an idea submission number ranking by department, a distribution heat map of an overall contribution degree, a radar chart by evaluation item for each idea, a project progress Gantt chart, and an innovation tendency analysis graph of the entire organization. For example, “a department with the largest number of idea submissions this month”, “an idea that obtained the highest evaluation in the past half year”, “an employee whose evaluation score rapidly increased”, and the like can be extracted and displayed with one click. On the terminal side, the employee himself/herself can browse his/her own evaluation status, past submission history, and feedback history, and a supervisor and an administrator can overlook a status of a subordinate and the entire organization. Specifically, the visualization display unit acquires a time-series evaluation score array and an aggregation tensor by category from a back-end database. The visualization display unit converts this data into structured data in a JSON format interpretable by a front-end drawing library. The visualization display unit dimensionally compresses a high-dimensional performance feature vector into two-dimensional coordinate data using a principal component analysis algorithm. The visualization display unit generates a scatter plot indicating a distribution of employees using this two-dimensional coordinate data. The visualization display unit executes a K-Means method which is a clustering algorithm. The visualization display unit classifies employees into a plurality of clusters having similar performance tendencies. The visualization display unit calculates center coordinates and variance of each cluster and maps them as a color distribution on a heat map. The visualization display unit applies an autoregressive moving average model to time-series data. The visualization display unit calculates a prediction curve of the number of future idea submissions and superimposes and displays it on a graph. The visualization display unit transmits these drawing data to the terminal via an HTTPS protocol. A browser on the terminal side renders these graphs at high speed by hardware acceleration using WebGL. The system converts a huge amount of evaluation data into intuitively understandable visual information by the above series of processes. The system improves a decision-making speed of an administrator and supports data-driven organization management. The system is applied to a company-wide innovation dashboard for a management layer, a resource optimization tool for a department head, and the like.

Step 5: Reward and Commendation Design by Generative AI A reward design unit on the server side performs multivariate analysis on an overall contribution degree, a past commendation history, an employee's motivation tendency, an organization's reward policy, a budget status, an employee's career orientation, a past incentive response, and the like using generative AI, and automatically designs a reward and commendation content optimized for each employee. For example, it proposes a combination of various incentives according to an organizational culture and an employee's orientation, such as a special commendation, a monetary bonus, a stock option, a promotion recommendation, selection as a new project leader, a right to participate in overseas training, an invitation to an internal event, a right to attend skill-up training, an introduction in internal public relations, and granting of internal points. As a specific example of a prompt sentence to be read by the generative AI, “Design an optimal reward and commendation plan in consideration of the overall contribution degree, past commendation history, motivation tendency, and organizational reward policy of employee X. Explain the proposal content together with a basis.” and the like can be cited. Specifically, the reward design unit drives a reward optimization agent implementing a reinforcement learning algorithm. The agent observes attribute data and an overall contribution degree score of the employee as a state vector from an environment. The agent defines a combination of available incentives as an action space. The agent receives a performance change after past incentive granting as a reward signal. The agent updates a state-action value function using a Q-learning algorithm. The agent outputs a combination of incentives that maximizes an expected reward for a current state vector. The reward design unit inputs this output result to a large language model. The large language model receives this combination data and a career orientation text of the employee as a prompt. The large language model outputs structured JSON data including a proposal reason in natural language and a specific granting plan. The reward design unit parses this JSON data and collates it with a budget management database. The reward design unit determines it as a final reward plan only when a budget constraint is satisfied. The system automates personalized incentive design that cannot be realized by a uniform reward system by the above series of processes. The system maximizes employee engagement and contributes to a decrease in a turnover rate. The system is applied to reward optimization for employees having diverse values in a global company, dynamic commission design in a sales organization, and the like.

Step 6: Feedback Generation by Generative AI A feedback generation unit on the server side automatically generates an evaluation result and an improvement proposal using generative AI. For example, when innovativeness of an idea is high but feasibility is low, it presents a specific action plan such as “recommending cooperation with an internal expert to solve a technical problem” and “expecting improvement in feasibility by conducting an additional market research”. Conversely, when feasibility is high but an economic impact is limited, it generates practical advice such as “considering collaboration with another department to maximize a cost reduction effect” and “recommending pilot introduction as an additional proposal to an existing customer”. Feedback is distributed to an employee and a supervisor through a plurality of channels such as a dashboard on the terminal side, an email notification, and chatbot linkage. As a specific example of a prompt sentence to be read by the generative AI, “Generate a specific improvement proposal and a future action plan for an employee based on the following evaluation result. Evaluation result: innovativeness 8 points, feasibility 5 points, economic impact 7 points.” and the like can be cited. Specifically, the feedback generation unit adopts a conditional text generation model. The generation unit encodes an array of evaluation scores and a category label of the idea as a condition vector. The generation unit inputs this condition vector to a transformer-based decoder network. The decoder network is pre-trained using a corpus of past excellent feedback texts. The decoder network sequentially calculates an appearance probability distribution of a word based on the condition vector. The decoder network generates a text sequence with the highest likelihood using a beam search algorithm. The generation unit extracts a list of specific action plans from this text sequence. The generation unit collates this list with an internal human resource database. The generation unit specifies an ID list of internal experts having a skill related to the action plan. The generation unit dynamically embeds a contact link of this expert in the feedback text. The generation unit transmits this rich text data to a chatbot server via a messaging API. The chatbot server transmits a push notification to a terminal of the employee. The system automatically prompts a specific and executable improvement action that is not limited to mere presentation of a score by the above series of processes. The system speeds up a brush-up cycle of an idea and improves a final commercialization success rate. The system is applied to mentoring automation for a young researcher in a research and development department, automatic correction of a proposal document in a planning department, and the like.

Step 7: Progress Reporting and Impact Prediction by Generative AI A progress reporting unit on the server side analyzes an evaluation status and progress of an idea, a prediction of an impact on work, and the like using generative AI, and automatically generates a report viewable by all related parties in real time. For example, it generates a detailed report including progress and an impact prediction, such as “a new service proposal is currently in a demonstration experiment stage, and a sales increase effect is expected in an initial evaluation” and “a business process automation plan requires additional consideration because a technical problem remains”, and distributes it to a related party by a dashboard on the terminal side, an email notification, or the like. As a specific example of a prompt sentence to be read by the generative AI, “Predict a future business impact based on the following progress status and evaluation history of an idea, and generate a progress report for a related party.” and the like can be cited. Specifically, the progress reporting unit drives a long short-term memory network which is a time-series prediction model. The progress reporting unit inputs progress milestone data and resource consumption of a past project as a time-series tensor. The long short-term memory network calculates a delay probability and a final cost overrun risk of the project from this time-series tensor. The long short-term memory network outputs a prediction score indicating an achievement degree at a specific point in time in the future. The progress reporting unit integrates this prediction score and current status data and inserts them into a prompt template. The progress reporting unit inputs this prompt to a large language model. The large language model generates a report text according to a format of a professional business document. The progress reporting unit applies a named entity recognition algorithm to this report text. The progress reporting unit highlights a risk factor and an important milestone in the text. The progress reporting unit converts this processed text into an HTML format and deploys it to an internal portal server. At the same time, when a risk score exceeds a threshold, the progress reporting unit automatically generates an alert email addressed to an administrator and transmits it via an SMTP server. The system automates progress management of a project and actualizes a potential risk at an early stage by the above series of processes. The system reduces management man-hours of a project manager and improves a project success rate of the entire organization. The system is applied to progress tracking of agile development in system development, automatic report generation of construction period management in a construction industry, and the like.

### Specific Use Case

For example, when an employee submits a new idea aimed at improving internal work efficiency from a terminal, the idea receiving unit receives a title “Proposal of an expense settlement automation system utilizing AI” input by the employee, content as a detailed explanation “Current expense settlement work involves a lot of manual work, and application errors and approval delays frequently occur. By realizing automatic receipt reading, automatic checking of application content, and optimization of an approval flow by AI, a work burden is significantly reduced, and transparency and accuracy of expense settlement are improved.”, an existing work flow chart and an external AI technology explanation article as a related material, submitter information, a submission date and time, a related project name “Accounting work DX”, an expected effect “50% reduction in expense settlement man-hours, 80% reduction in application errors”, and the like, and immediately records them in a database management unit on a server side. The receiving unit automatically searches for a similar idea submitted in the past, such as “Expense settlement work improvement” or “Office work automation by AI utilization”, based on the input content, and presents it to the employee as reference information. Specifically, the receiving unit divides the input text data in units of characters and generates an initial feature vector using an N-gram model. The receiving unit inputs this initial feature vector into a pre-trained language model and outputs a 768-dimensional dense vector considering a context. The receiving unit extracts text data from a PDF file uploaded as the related material using an optical character recognition engine. The receiving unit similarly converts this extracted text into a dense vector. The receiving unit integrates the respective vectors of the title, the detailed explanation, and the related material by an average pooling process to generate a single proposal representation vector. The receiving unit inputs this proposal representation vector into an HNSW index which is an approximate nearest neighbor search algorithm. The index searches for top five similar idea vectors having the closest Euclidean distance from a database of millions of past ideas in units of milliseconds. The receiving unit returns metadata of this search result to the terminal in a JSON format. An application on the terminal side analyzes this JSON data and dynamically renders a link of a similar proposal on a sidebar on a screen. The system accurately captures a semantic structure of the input data and realizes a high-speed and highly accurate similarity search by the above series of processes. The system provides an environment in which the employee can immediately refer to past knowledge, and improves the quality of the proposal. The system is applied to automatic classification of an improvement request from a citizen in a local government, a similar event search of a customer's voice in a call center, and the like.

The automatic evaluation index calculation unit analyzes the submitted idea explanatory text and attached material using generative AI. The generative AI extracts keywords such as “automatic receipt reading by AI”, “automatic checking of application content”, and “optimization of an approval flow” by natural language processing technology, collates them with internal and external knowledge bases, a past similar proposal, industry news, a patent database, and an academic paper database, and determines a difference from existing technology and novelty. For example, when “automatic receipt input by OCR” exists in a past internal proposal, the generative AI emphasizes the novelty of the “automatic checking of application content by AI” and “optimization of an approval flow” parts, and uses them as an evaluation basis. In a feasibility evaluation, a risk factor and a realization condition are extracted by referring to an enrollment status of an internal AI engineer, availability of linkage with an existing system, a success rate of a past AI introduction project, a collaboration record with an external vendor, a legal regulation, a personal information protection requirement, and the like. In an economic impact evaluation, a quantitative effect of a sales increase or a cost reduction is calculated using annual man-hours of expense settlement work, an effect of a past work improvement measure, a cost reduction simulation by AI introduction, ROI data of a similar case of another company, and the like. As a specific example of a prompt sentence to be read by the generative AI, “Analyze the following idea explanatory text, evaluate it on a 10-point scale from three viewpoints of innovativeness, feasibility, and economic impact, and calculate a total evaluation score together with a basis for each viewpoint. Idea explanatory text: ‘Proposal of an expense settlement automation system utilizing AI. Current expense settlement work involves a lot of manual work, and application errors and approval delays frequently occur. By realizing automatic receipt reading, automatic checking of application content, and optimization of an approval flow by AI, a work burden is significantly reduced, and transparency and accuracy of expense settlement are improved.’” and the like can be cited. Specifically, the calculation unit inputs the extracted keyword group into a graph neural network. The graph neural network constructs a knowledge graph using a keyword as a node and a co-occurrence relationship as an edge. The graph neural network executes a message passing algorithm on this knowledge graph and updates a feature representation of each node. The calculation unit calculates a cosine similarity with a patent classification code of an external database or a keyword vector of a paper using this updated feature representation. The calculation unit specifies a node having a low similarity as an element having high novelty. The calculation unit acquires an operation rate and a skill set of an engineer as a numerical matrix from an internal resource database in order to evaluate feasibility. The calculation unit executes a linear programming solver using this numerical matrix as a constraint condition. The solver calculates an optimal solution of resource allocation that maximizes a completion probability of a project, and outputs its objective function value as a feasibility score. The calculation unit constructs a regression model from past financial data in order to evaluate an economic impact. The regression model receives a man-hour reduction rate as an input and outputs a predicted value of an annual cost reduction amount. The calculation unit integrates these scores and generates a final evaluation vector. The calculation unit transmits this evaluation vector to a subsequent dashboard update module. The system converts a qualitative idea explanatory text into a quantitative evaluation index based on a strict mathematical model by the above series of processes. The system eliminates human bias and dramatically improves the accuracy of investment judgment. The system is applied to automation of loan examination in a financial institution, optimization of a capital investment plan in a manufacturing industry, and the like.

The work performance integration unit automatically collects a work evaluation score of an accounting department, a project achievement degree (e.g., a progress rate and deliverable quality of an accounting work DX project), attendance data (e.g., an attendance rate and overtime hours), an internal and external commendation history (e.g., a past work improvement commendation), a skill-up training attendance history (e.g., an AI technology training attendance history), and the like as performance data regarding normal work of an employee, and integrates them with evaluation indices to calculate an overall contribution degree. For example, when the employee has achieved a high result in an AI-related project in the past, weighting is adjusted so that the reliability of a feasibility evaluation increases. Specifically, the integration unit formats the performance data acquired from a personnel system as time-series tensor data. The integration unit inputs this tensor data into a one-dimensional convolutional neural network. The convolutional neural network extracts a fluctuation pattern of performance along a time axis and generates a feature map. The integration unit inputs this feature map into a fully connected layer and outputs a latent vector indicating a skill level of the employee. The integration unit multiplies this latent vector and an evaluation vector of an idea element by element to generate an interaction vector. The integration unit inputs this interaction vector into a softmax function and calculates a dynamic weighting coefficient for each evaluation item. The integration unit calculates a weighted average of the evaluation vector using this weighting coefficient and derives a final overall contribution degree score. When this score exceeds a predetermined threshold value, the integration unit triggers a process of adding the employee to a high performer list. The system realizes a dynamic and adaptive evaluation mechanism based on a past record of the employee instead of a static evaluation rule by the above series of processes. The system fairly evaluates a hidden ability of the employee and promotes optimal placement of human resources. The system is applied to skill evaluation of an engineer in an IT company, performance management of a medical worker in a hospital, and the like.

The visualization display unit displays evaluation data and performance data on a dashboard, and provides, for example, an evaluation transition graph of “Expense settlement automation system proposal”, an idea submission number ranking within an accounting department, a heat map of an overall contribution degree, a radar chart by evaluation item, a project progress Gantt chart, and the like. The employee himself/herself can browse his/her own evaluation status and feedback history, and a supervisor and a manager can have a bird's-eye view of an innovation tendency of the entire department and a contribution degree for each employee. Specifically, the visualization display unit asynchronously acquires the latest evaluation score array from a back-end server via a RESTful API. The visualization display unit stores this array data in a state management library of a front end. The visualization display unit dynamically generates an SVG element using a data-driven document object model manipulation library. The visualization display unit converts a score of each evaluation item into a vector in a polar coordinate system in drawing the radar chart. The visualization display unit calculates an area of a polygon connecting end points of this vector and displays it on a tooltip as a comprehensive balance index. The visualization display unit inputs an overall contribution degree score into a color scale function and outputs a corresponding RGB value in drawing the heat map. The visualization display unit updates a background color of each cell in real time using this RGB value. The visualization display unit monitors a user's click event and executes a callback function that displays detailed data in a modal window when a specific data point is selected. The system converts complex multidimensional data into an intuitive graphical interface by the above series of processes. The system reduces a user's cognitive load and supports quick decision-making based on data. The system is applied to sales performance analysis by store in a retail industry, an efficiency improvement dashboard of a delivery route in a logistics industry, and the like.

The reward design unit performs multivariate analysis on an overall contribution degree, a past commendation history, a motivation tendency of an employee, an organizational reward policy, a budget status, a career orientation, a past incentive response, and the like using generative AI, and automatically designs an optimal reward and commendation plan according to an employee's orientation and an organizational culture, such as “special commendation +monetary bonus”, “selection as an accounting work DX project leader”, “right to participate in AI technology training”, and “introduction in internal public relations”. As a specific example of a prompt sentence to be read by the generative AI, “Design an optimal reward and commendation plan in consideration of an overall contribution degree, a past commendation history, a motivation tendency, and an organizational reward policy of an employee X. Explain proposal content together with a basis.” and the like can be cited. Specifically, the reward design unit combines attribute data of the employee and an overall contribution degree score to generate an input feature vector. The reward design unit inputs this input feature vector into a random forest classifier. The classifier is trained using past reward grant data and an employee satisfaction questionnaire result as teacher data. The classifier outputs a probability distribution vector indicating an acceptance probability of each reward category based on the input feature vector. The reward design unit selects top three reward categories having the highest probability in this probability distribution vector. The reward design unit inputs this selected category and budget constraint data into a constraint satisfaction problem solver. The solver calculates a specific reward amount and a combination of benefits that bring about a maximum expected satisfaction value within a budget. The reward design unit embeds this calculation result as structured data into a prompt template of a large language model. The large language model analyzes this prompt and generates a text of a personalized reward proposal for the employee. The reward design unit automatically transmits this text to an approval workflow module of a personnel system. The system realizes data-driven objective reward design by the above series of processes. The system prevents a reward mismatch and maximizes employee motivation within a limited budget. The system is applied to dynamic optimization of an incentive plan in a sales department, a reward algorithm in a freelance platform, and the like.

The feedback generation unit automatically generates an evaluation result and an improvement proposal using generative AI. For example, when innovativeness is high but feasibility is medium, it presents a specific action plan such as “It is recommended to consider collaboration with an external vendor in order to supplement internal resources of AI technology” and “Regarding an automatic checking function of application content, it is desirable to identify a technical problem of API linkage with an existing system in advance”. As a specific example of a prompt sentence to be read by the generative AI, “Generate a specific improvement proposal and a future action plan for an employee based on the following evaluation result. Evaluation result: innovativeness 9 points, feasibility 6 points, economic impact 8 points.” and the like can be cited. Specifically, the feedback generation unit receives a vector of an evaluation score as an input and drives a hybrid inference engine combining a rule-based expert system and a neural network. The inference engine compares the score vector and a predefined threshold matrix to specify an evaluation item that becomes a weakness. The inference engine searches a vector database for text data of a past success case related to this weakness item. The inference engine combines the searched text data and a current idea explanatory text to generate a context vector. The feedback generation unit inputs this context vector into a large language model. The large language model focuses on an important keyword in a context using an attention mechanism. The large language model outputs a text sequence in a natural language including a solution to a specific technical problem and an alternative plan for resource procurement. The feedback generation unit extracts a pair of a verb and an object from this text sequence using a natural language processing library. The feedback generation unit converts this pair into an API format of a task management system and automatically registers it as a ToDo list. The system converts an abstract evaluation result into a specific action instruction by the above series of processes. The system smoothes transition of an idea to an execution phase and prevents stagnation of a project. The system is applied to automatic correction of a student's report in an educational institution, automation of code review in software development, and the like.

The progress reporting unit analyzes an evaluation status and progress of an idea, a prediction of an impact on work, and the like using generative AI, generates a detailed report including progress and an impact prediction, such as “An expense settlement automation system proposal is currently in a requirement definition stage, and a 50% reduction in expense settlement man-hours and an 80% reduction in application errors are expected in an initial evaluation” and “Since a technical problem of system linkage accompanying AI introduction remains, additional consideration is necessary”, and distributes it to a related party by a dashboard, an email notification, or the like. As a specific example of a prompt sentence to be read by the generative AI, “Predict a future business impact based on a progress status and an evaluation history of the following idea, and generate a progress report for a related party.” and the like can be cited. Specifically, the progress reporting unit periodically fetches a numerical array indicating a completion rate of a task and consumed man-hours from a project management database. The progress reporting unit inputs this numerical array into a Kalman filter algorithm. The algorithm removes observation noise and estimates a true progress state vector of a project. The progress reporting unit calculates a probability distribution for predicting a future scheduled completion date and a final cost using this state vector. The progress reporting unit extracts an average value and a variance of this probability distribution and formats them as impact prediction data. The progress reporting unit inputs this prediction data and a current problem list into a large language model. The large language model integrates these quantitative data and qualitative data and generates a report text having a logical structure. The progress reporting unit applies an emotion analysis model to this report text. The progress reporting unit checks whether a tone of the text is excessively pessimistic or optimistic, and automatically corrects an expression as necessary. The progress reporting unit passes this final text to a PDF generation library and outputs a formatted document. The progress reporting unit automatically distributes this document to a mailing list of related parties. The system ensures transparency of a project and streamlines information sharing among stakeholders by the above series of processes. The system is applied to automatic material creation for a management meeting, automatic generation of an IR report for an investor, and the like.

In this way, the system of the present invention can automate and sophisticate a series of processes from submission of a specific work improvement idea by an employee to multifaceted automatic evaluation by generative AI, integration with work performance, visualization, optimal reward design, specific feedback generation, and progress reporting, and can maximize innovation promotion and human resource utilization of an organization. Specifically, the system is implemented as a plurality of independent microservice architectures. The system connects respective modules by an asynchronous message queuing protocol. The system dynamically scales a calculation resource of each module by a container orchestration tool according to a traffic volume of input data. The system offloads an inference process of an evaluation model or a prediction model to a parallel calculation cluster using a GPU. Thereby, the system responds with low latency even to simultaneous access from tens of thousands of employees and a huge data processing request. The system caches intermediate data generated in each processing step in a distributed in-memory database. Thereby, the system minimizes a data reading overhead of a subsequent process. The system constructs a continuous integration and continuous delivery pipeline of a machine learning model. The system periodically re-trains a weight of the model using newly accumulated evaluation data, and continuously improves inference accuracy. The system realizes a processing speed and scalability unreachable by a conventional manual management method by integration of these advanced computer technologies. The system accelerates digital transformation of a company and becomes a source of competitive advantage. The system is applied to a company-wide ideathon management platform in a large company, a cloud service promoting open innovation, and the like.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

In the embodiment of the present invention, an on-site proposal evaluation and management system in a factory robot field has an extremely thick system configuration for maximizing on-site-led innovation by placing generative AI at a core and comprehensively utilizing various information such as knowledge of an on-site employee and an engineer, on-site data, an operation record, human resource information of an organization, and external technology information. Specifically, the system adopts a distributed processing architecture in which an edge computing device and a cloud server are linked. The system executes primary processing of sensor data by an edge device arranged in each robot cell in a factory. The edge device filters high-frequency vibration data and temperature data in real time and extracts a feature vector. The edge device transmits this feature vector to the cloud server using a lightweight communication protocol. A control unit on the cloud server side integrates the received feature vector and text data input from the employee. The control unit inputs this integrated data into a multimodal neural network. The network fuses an embedding vector of a text and the feature vector of the sensor data using a cross-attention mechanism. The network outputs a high-dimensional representation tensor associating a physical state of a site with human tacit knowledge. The system supplies this representation tensor to a subsequent evaluation module and prediction module. The system seamlessly integrates data of a cyber space and a physical space by the above series of processes. The system captures a minute change of the site and realizes precise evaluation of an improvement proposal based on data. The system is applied to optimization of a predictive maintenance system in an automobile manufacturing line, automatic evaluation of a yield improvement proposal in a semiconductor factory, and the like.

First, the idea receiving unit enables an on-site employee and an engineer to submit an improvement point and a new proposal noticed during daily work and robot operation from various devices such as a PC, a tablet, a smartphone, and a dedicated terminal in a factory. For example, proposals for all on-site problems and room for improvement are targeted, such as optimization of an operation pattern of a collaborative robot, an automation algorithm for picking work, introduction of anomaly detection AI, energy-saving operation scheduling, a wear prediction model for a robot arm, enhancement of safety control during collaboration with a worker, redesign of a line layout, an automation proposal for maintenance and inspection, improvement of an inter-robot communication protocol, and a visualization dashboard proposal for on-site data. The receiving unit receives extremely diverse data such as a title, a detailed explanation, a related material (an on-site drawing, a work video, a sensor log, a simulation result, an external technical material, a reference paper URL, a patent document number, etc.), submitter information (an employee ID, an affiliated line, a process in charge, a job title, contact information, etc.), a submission date and time, a related project name, an expected effect (a productivity improvement rate, a cost reduction amount, a defective product rate reduction, the number of safety incident reductions, an energy consumption reduction amount, etc.), a problem and a risk, and external information serving as a reference. For example, when a worker submits a proposal “optimizing an operation pattern of a collaborative robot with AI to improve efficiency and safety of picking work” together with a sensor log and an on-site video, the receiving unit transmits these data to a server by encrypted communication, and also realizes version control of submission content, automatic search and presentation of a similar idea, a preview before submission, editing and postscript after submission, automatic tagging to the submission content, time-series management of a submission history, multilingual automatic translation of the submission content, an anonymous submission function, automatic summarization of the submission content, and the like. Specifically, the receiving unit divides the input work video data in units of frames and inputs them to a three-dimensional convolutional neural network. This network extracts spatiotemporal features and outputs a 512-dimensional vector indicating an operation pattern of the video. The receiving unit converts time-series data of the attached sensor log into frequency domain data by a fast Fourier transform algorithm. The receiving unit encodes this frequency data as a spectrogram image, inputs it to an image recognition model, and extracts a feature vector of an anomaly pattern. The receiving unit applies a pre-trained multilingual language model to text data. This model maps the input text to a common latent space vector independent of language. The receiving unit drives an automatic translation module using this latent space vector and outputs text in a designated language. The receiving unit combines these video feature vector, sensor feature vector, and text latent vector to generate an integrated proposal tensor. The receiving unit inputs this integrated proposal tensor to a clustering algorithm and specifies a similar past proposal group. The receiving unit extracts metadata of this specified proposal group and suggest-displays it on a screen of the terminal. The system converts unstructured and multimodal on-site data into a mathematical representation processable by a computer through the above series of processing. The system enables sharing of global knowledge beyond language barriers and eliminates duplication of proposals. The system is applied to an improvement case sharing platform for global factories in a multinational company, automatic aggregation of safety measure proposals at a construction site, and the like.

The automatic evaluation index calculation unit analyzes an explanatory text and an attached material of the submitted idea from multiple viewpoints using generative AI. The generative AI extracts a gist and a technical feature of the proposal by natural language processing, and specifies a keyword and a logical structure such as “operation optimization by AI”, “sensor data utilization”, and “safety enhancement measure”, for example. By combining image analysis and time-series data analysis, a change in an operation pattern, a sign of anomaly occurrence, a relative positional relationship between a worker and a robot, a bottleneck in a process, a transition of an operation rate of a robot, an abnormal stop frequency, an interference status between a flow line of a worker and a robot operation, and the like are automatically extracted from the attached on-site video and sensor log. For example, various analyses are performed, such as analyzing an acceleration change of a robot arm from a sensor log to detect wear and an anomaly sign, extracting a flow line of a worker and an operation pattern of a robot from an on-site video to specify a safety risk and room for efficiency improvement, quantitatively evaluating a cycle time reduction effect at the time of introducing a new algorithm from a simulation result, and determining the presence or absence of a similar technology and innovativeness from an external technical material and a patent document. The generative AI collates with internal and external knowledge bases, a past improvement case, an industry technology trend, patent information, an academic paper, on-site operation record data, external safety standard information, and the like, scores each viewpoint of innovativeness (difference from existing technology and novelty), feasibility (on-site technical resource, introduction cost, schedule, maintenance system, legal regulation conformity, etc.), productivity/quality impact (cycle time reduction, defective product rate reduction, operation rate improvement, yield improvement, etc.), and safety (collaborative risk reduction with a worker, anomaly detection accuracy, emergency stop function, international safety standard conformity, etc.) on a 10-point scale, and automatically generates a basis for each viewpoint. For example, it presents a specific analysis result such as “an optimization method of an operation pattern is novel compared to an existing collaborative robot operation case, and a safety enhancement measure utilizing on-site sensor data is also highly unique”, “compatibility between an on-site robot control system and an existing AI algorithm is high, and an introduction cost is also within an allowable range”, “a cycle time reduction effect of picking work is confirmed by 15% in a simulation”, and “an interference risk between a flow line of a worker and a robot operation is reduced”. Furthermore, the AI can execute an evaluation process in a plurality of times, and automatically designs a stepwise evaluation flow such as a primary evaluation immediately after submission, a re-evaluation after an on-site test, and an effect verification evaluation after introduction. Specifically, the calculation unit inputs a frame image extracted from an on-site video to a posture estimation algorithm. This algorithm outputs skeleton coordinate data of a worker and arm joint coordinate data of a robot as a time-series tensor. The calculation unit inputs this coordinate tensor to a graph convolutional network. This network calculates a physical distance and an approach speed between a worker and a robot, and outputs a safety score indicating a collision risk. The calculation unit inputs acceleration data of a sensor log to an autoencoder. This autoencoder is pre-trained with data at a normal time, and calculates an error between input data and reconstructed data. The calculation unit outputs this reconstruction error as an anomaly degree score, and quantifies a sign of wear and failure. The calculation unit vectorizes a technical keyword group extracted from a proposal text, and executes a cosine similarity search on a vector index of a patent database. The calculation unit calculates a ratio of a technical element whose similarity is equal to or less than a predetermined threshold, and outputs it as an innovativeness score. The calculation unit integrates these safety score, anomaly degree score, and innovativeness score, and inputs them to a multilayer perceptron. This multilayer perceptron outputs a final 10-point scale evaluation score of each viewpoint. The calculation unit embeds this evaluation score in a prompt of a large language model. The large language model generates an analysis report text in natural language serving as a basis for the score. The calculation unit saves this report text in a database, and transmits a notification to a subsequent approval workflow module. The system automates highly accurate video analysis and waveform analysis impossible by human visual inspection through the above series of processing. The system ensures objectivity of evaluation and simultaneously improves on-site safety and productivity. The system is applied to operation optimization of an automated guided robot in a distribution warehouse, automatic evaluation of a hygiene management process in a food factory, and the like.

The work performance integration unit automatically collects extremely diverse performance data such as a productivity index (e.g., the number of processing per hour, in-process work efficiency), a quality control score (e.g., a defective product rate, an in-process inspection pass rate), a safety compliance rate (e.g., the number of accident-free days, the number of near-miss reports), a past commendation history (e.g., a business improvement commendation, a quality improvement commendation, a safety commendation), a skill-up training attendance history (e.g., AI technology training, a robot maintenance course, on-site safety education), a leader experience on site, a participation history in an on-site improvement activity, an on-site communication score, an evaluation by others on site, an inter-site transfer history, and a multi-skilled worker degree on site of an on-site employee and an engineer, and integrates them with an idea evaluation score by AI to calculate an overall contribution degree. For example, when a worker maintaining high productivity and a high safety compliance rate on site makes an excellent proposal, the overall contribution degree becomes high, and a priority of a reward and a commendation also rises. A weighting pattern is customizable according to a policy of a site and an organization, and is automatically adjusted according to an evaluation policy such as an “innovation-oriented type”, a “safety-oriented type”, a “quality-oriented type”, and an “on-site contribution-oriented type”, for example. Furthermore, the AI also learns a past contribution tendency and a growth curve of an employee, and can also realize future potential evaluation, automatic extraction of a promotion candidate, an optimization proposal for personnel placement on site, and the like. Specifically, the integration unit normalizes a productivity index and a quality control score acquired from a manufacturing execution system to generate a multidimensional performance vector. The integration unit inputs this performance vector to a recurrent neural network. This network learns a time-series change in performance over the past several years, and outputs a gradient vector indicating a growth rate of an employee. The integration unit combines this gradient vector and a current performance vector to calculate a potential ability score. The integration unit converts categorical data indicating an evaluation policy of an organization into a one-hot vector. The integration unit inputs this one-hot vector to an attention network. This network outputs a dynamic weighting coefficient matrix for each element of the performance vector according to the evaluation policy. The integration unit integrates this weighting coefficient matrix, the performance vector, and a vector of the idea evaluation score by a matrix multiplication operation. The integration unit calculates a final overall contribution degree score from this operation result. The integration unit inputs this overall contribution degree score and potential ability score to a clustering algorithm. This algorithm classifies an employee into a category such as a next-generation leader candidate and a specialist of a specific technology. The integration unit transmits this classification result to a personnel placement optimization module. This module matches a skill requirement matrix of each process with the classification result of the employee, and outputs an optimal personnel placement plan. The system realizes advanced personnel evaluation including future growth potential, not limited to mere past performance evaluation, through the above series of processing. The system supports human resource development matching a strategy of an organization, and maximizes labor productivity. The system is applied to skill succession of a skilled engineer in plant engineering, dynamic personnel placement in a high-mix low-volume production line, and the like.

The visualization display unit displays evaluation data and performance data on a dashboard in various formats. For example, it provides extremely diverse visualization patterns such as an evaluation transition graph for each proposal, an idea submission number ranking by site and by worker, a heat map of an overall contribution degree, a radar chart by evaluation item, a progress Gantt chart of an improvement proposal, an innovation tendency analysis graph of the entire site, a safety score transition for each site, communication network visualization within a site, an idea distribution map between sites, a commendation history distribution for each site, and a skill map for each site. A manager can grasp at a glance what kind of proposal is frequent at which site, which worker contributes to innovation, which evaluation item is weak in the entire organization, a knowledge distribution status between sites, maturity of a safety culture for each site, and the like. An employee himself/herself can browse his/her own evaluation status, feedback history, past submission history, his/her own positioning within a site, and information that can be utilized for self-growth and career formation. Specifically, the visualization display unit includes a dedicated rendering engine constructed in a server. This rendering engine converts a multidimensional evaluation data vector acquired from a database into two-dimensional or three-dimensional coordinate data for display. The system executes a dimensionality reduction algorithm such as t-SNE or UMAP in this conversion processing. This processing unit performs mapping to a low-dimensional space while maintaining a distance relationship between data points in a high-dimensional space. The system generates a heat map of an overall contribution degree and a node-link diagram of a communication network using this mapping result. The visualization display unit serializes the generated chart data into a drawing object conforming to a JSON format. The system transmits this serialized data to a client terminal. A browser on the client terminal side calls a graphics API such as WebGL based on the received data. This terminal draws tens of thousands of data points on a screen without delay using hardware acceleration of a GPU. The system exerts a technical effect of visualizing a large amount of performance data and evaluation history in real time through this series of processing. This processing unit dynamically recalculates display data according to a filtering condition designated by a manager. The system reduces the number of query issues to a database accompanying recalculation by utilizing an in-memory cache. This configuration significantly reduces a CPU load of a server and consumption of a network bandwidth. The system exhibits extremely high responsiveness in a use case of simultaneously monitoring employee data on a scale of thousands of people at a large-scale manufacturing site. The visualization display unit also provides a personalized view for a dashboard of an individual employee. The system verifies a security token indicating an access authority of each employee, and strictly controls a browsable data range. This processing unit safely provides necessary feedback information while preventing information leakage by this access control. The system fundamentally improves efficiency and speed of information presentation using computer-specific technologies of mathematical dimensionality reduction of high-dimensional data and parallel drawing processing using a GPU, rather than simply imitating a human visual cognitive process.

The reward design unit performs multivariate analysis on an overall contribution degree, a past commendation history, a motivation tendency of an employee and an engineer, an on-site reward policy, a budget status, a career orientation, a past incentive response, a leader experience on site, a participation history in an on-site improvement activity, a personnel placement status on site, a reward history distribution for each site, and the like using generative AI, and automatically designs various reward and commendation plans according to an on-site and individual orientation, such as a special commendation, a monetary reward, selection as an on-site improvement project leader, a right to participate in joint development with a robot maker, granting of skill certification points, a right to participate in skill-up training, introduction in internal public relations, an on-site event invitation, an inter-site transfer recommendation, granting of authority to launch a new project on site, and a mentor role recommendation on site. For example, selection as a project leader and granting of skill certification points are prioritized for an employee with a strong career advancement orientation, and a monetary reward and a special commendation are designed for an employee who emphasizes a monetary reward. A basis for reward design and an expected effect are also automatically generated as an explanatory text by the AI, and presented to an employee and a manager. Specifically, the reward design unit includes a large language model and a reinforcement learning agent based on an autoregressive transformer architecture. The system converts profile data of an employee into a numerical vector and inputs it to the AI model. Input data to the AI model includes a numerical value such as 85 which is a scalar value indicating an overall contribution degree, a three-dimensional array indicating the number of commendations in the past three years, for example, which is a time-series vector indicating a past commendation history, a 768-dimensional vector in which a natural language text indicating a motivation tendency is embedded, and the like. The AI model combines these input vectors and calculates a representation of a hidden layer through a multilayer perceptron. Output data from the AI model includes a numerical array indicating, for example, a special commendation 0.1, a monetary reward 0.6, and selection as a project leader 0.3, which is an output value of a softmax function indicating a probability distribution for each reward plan, and character string data such as “a monetary reward is recommended because of a good response to a monetary reward”, for example, which is a text token sequence indicating a generated explanatory text. The system utilizes this output result in subsequent processing. This processing unit selects a plan having a maximum value of the probability distribution, and inserts a record into a reward schedule table of a database. The system continuously updates a weight parameter of the AI model using a proximal policy optimization algorithm using past reward granting and a subsequent performance change as a reward signal. This configuration eliminates a subjective and time-consuming reward determination process by a human manager, and replaces it with an objective and instantaneous optimization calculation based on multidimensional data. The system realizes efficient allocation of calculation resources by this processing, and exerts a technical effect of dramatically shortening a processing time by automation of personalized reward design. The system fundamentally improves data processing capability of a personnel management system in a use case of generating an individual reward plan for thousands of employees in real time.

The feedback generation unit automatically generates a specific improvement proposal and action plan based on an evaluation result by AI, such as “feasibility of an operation pattern optimization plan increases by analyzing on-site sensor data in more detail”, “it is recommended to implement an additional risk assessment to enhance safety evaluation”, “additional learning data collection is effective for accuracy improvement of an anomaly detection algorithm”, “an effect of an energy-saving operation proposal is maximized by linking with an on-site operation schedule”, “an implementation cost can be suppressed by promoting collaboration with another department on site”, and “safety improvement can be expected by linking with an on-site worker education program”, for example, and distributes them to a worker and an engineer. Feedback is distributed through a plurality of channels such as a dashboard, an email notification, chatbot linkage, on-site bulletin board linkage, and automatic generation of an on-site morning assembly material, and a past response and an improvement history of an employee are also learned to evolve into more personalized content. Specifically, the feedback generation unit includes a large language model specialized for natural language generation. The system embeds score data output from an evaluation module in a prompt template, and inputs it to the AI model. Input data to the AI model includes a 4-dimensional vector indicating, for example, innovativeness 9, feasibility 6, productivity 8, and safety 7, which is an evaluation result vector, a 512-dimensional numerical array, for example, which is an embedding vector of a proposal text, and a past feedback history vector. The AI model weights an important feature in the input data using an attention mechanism, and calculates a probability distribution of a next word while maintaining a context. Output data from the AI model includes character string data such as “feasibility improves by increasing a sampling rate of a sensor”, for example, which is a text token sequence of an improvement proposal, and a numerical array indicating, for example, email 0.8 and dashboard 0.2, which is a selection probability vector of a distribution channel. The system utilizes this output result in subsequent processing. This processing unit converts the generated text into an API format of each distribution channel, and transmits it to a message queue. The system acquires data from the message queue using an asynchronous task worker, and issues an HTTP request to an external email server or chat system. This configuration prevents blocking of the system due to synchronous communication, and improves throughput for a large amount of feedback generation requests. The system continuously improves generation quality of the AI model by fine-tuning using a cross-entropy error function. The system exerts technical effects of latency reduction by optimization of natural language generation processing and improvement of personalization accuracy by this processing. The system eliminates a communication delay and dramatically enhances business efficiency in a use case of immediately presenting a specific improvement action to an on-site worker.

The progress reporting unit distributes a quantitative progress and effect prediction as a report to a related party, such as “an operation optimization proposal is currently in an on-site test stage, and a 15% improvement in picking work efficiency and a 20% reduction in a safety incident occurrence rate are expected in an initial evaluation”, “an anomaly detection AI introduction plan requires additional examination because a technical problem of system linkage remains”, “an energy-saving operation proposal is expected to reduce monthly energy consumption by 10%”, “simultaneous introduction is in progress in a plurality of lines on site, and an effect comparison between lines is also automatically aggregated”, and “a safety improvement measure linked with an on-site worker education program is in progress”, for example, by AI analyzing an evaluation status of a proposal, progress of on-site introduction, and a prediction of a business impact. A progress report is distributed to various related parties such as an on-site manager, a management layer, a related department, and an external partner by automatically adjusting a browsing authority and a reporting granularity. Specifically, the progress reporting unit includes a long short-term memory network or a transformer-based time-series prediction model. The system converts time-series progress data extracted from a database into a tensor format, and inputs it to the AI model. Input data to the AI model includes a time-series tensor indicating a status change in the past 30 days, for example, which is a past progress log, an integer value indicating a test stage, for example, which is a current status flag, and a floating-point number indicating an efficiency improvement rate of 15 percent, for example, which is an initial prediction value of a business impact. The AI model learns a long-term dependency relationship in time-series data, and performs regression prediction of a future numerical value. Output data from the AI model includes a continuous value vector indicating an efficiency improvement rate of 18 percent after 3 months, for example, which is a future business impact prediction value, and a character string such as “it is progressing smoothly, and further efficiency improvement is expected”, for example, which is a report text. The system utilizes this output result in subsequent processing. This processing unit executes branch processing of issuing an alert notification to a manager when a prediction value falls below a predetermined threshold. The system executes filtering processing based on a browsing authority matrix, and dynamically masks confidential information in a report according to a job title and an affiliated department of a user. This configuration exerts technical effects of processing speed improvement by parallelization of prediction calculation and security improvement by automation of access control. The system completely eliminates data aggregation and report creation work by human manual work, and instantaneously generates a report using a data-to-text conversion algorithm. The system makes an information transmission delay zero in a use case where a management layer grasps return on investment of a project in real time and makes a prompt decision.

Furthermore, for example, in order to cope with a multilingual environment on site, the generative AI automatically translates a submitted idea and feedback, and can also smoothly perform idea sharing and evaluation between global bases. For example, when it is desired to ensure anonymity of an employee, a function in which the generative AI masks submitter information and eliminates a bias at the time of evaluation can also be implemented. For example, when an external robot maker and an expert are made to participate in an evaluation process, the generative AI can automatically adjust an evaluation criterion and feedback content, and provide an interface for an external evaluator. For example, when a plurality of ideas are simultaneously progressing on site, a mechanism capable of visualizing each evaluation transition, feedback history, and progress status in time series and taking a bird's-eye view of an innovation activity of the entire site can also be implemented. For example, for fostering a safety culture on site, a function in which AI analyzes a frequency and content of a safety-related proposal, automatically evaluates safety culture maturity for each site, and promotes best practice sharing between sites can also be implemented. Specifically, the system includes a multilingual translation model and a named entity extraction model based on an encoder-decoder type transformer architecture. The system tokenizes input text data and inputs it to the AI model. Input data to the AI model includes a character code array indicating a Japanese proposal sentence, for example, which is a multilingual text, and an integer value indicating a source language ID and a target language ID, for example, which is metadata. The AI model generates a context vector of an input language by an encoder, and autoregressively generates a token sequence of a target language by a decoder. Output data from the AI model includes a character code array converted into English, for example, which is a translated text, and a character string in which a personal name and a department name are replaced with an asterisk, for example, which is a masked text. The system utilizes this output result in subsequent processing. This processing unit saves a translation result in an in-memory cache server, and omits re-translation processing for the same text. The system stores masked data in a dedicated anonymization database, and provides only this anonymized data in response to an access request from an evaluation module. This configuration exerts technical effects of reduction of calculation resources by integration of a natural language processing pipeline and technical guarantee of data privacy. The system dramatically enhances versatility and security of the system in a use case of sharing a technical proposal in real time beyond language barriers and implementing a fair examination eliminating an evaluation bias in a globally expanding manufacturing industry.

As described above, the embodiment of the present invention fuses knowledge of an on-site employee and an engineer and on-site data, seamlessly supports all on-site innovation activities such as multifaceted automatic evaluation, integration, reward design, feedback, progress management, multilingual support, anonymization, external linkage, inter-site knowledge distribution, and safety culture fostering by generative AI, and becomes an extremely practical and highly expandable system capable of efficiently and fairly promoting on-site-led continuous productivity, quality, and safety improvement in a factory robot field. Specifically, the system adopts a microservice architecture, and deploys each functional module as an independent container. The system dynamically scales the number of replicas of each module according to an increase or decrease in traffic using a container orchestration tool. The system adopts an asynchronous publish-subscribe model using a message queue for communication between modules. This configuration realizes fault tolerance that prevents a stop of the entire system even when a failure occurs in a specific module. The system accumulates on-site sensor data, employee input data, and data acquired from an external API in an integrated data lake, and continuously supplies them to a re-learning pipeline of each AI model. The system constructs a self-learning mechanism that improves inference accuracy of an AI model over time by automation of this data flow. The system replaces evaluation and management by human mental activity with a pure computer technical process of a matrix operation in a high-dimensional vector space, calculation of a probability distribution, and asynchronous messaging. The system achieves clear technical improvements of processing speed improvement, data management improvement, calculation efficiency improvement, and communication load reduction by this replacement. The system exhibits extremely high practicality and expandability in a use case of automating an innovation creation cycle at a system level and executing continuous optimization under a complex environment where tens of thousands of robots and thousands of employees collaborate in a large-scale smart factory.

### System Configuration

A system according to the present embodiment comprises an idea receiving unit, an automatic evaluation index calculation unit, a work performance integration unit, a visualization display unit, a reward design unit, a feedback generation unit, a progress reporting unit, a database management unit, a user authentication unit, and an external linkage unit. Specifically, the system operates on a distributed computing cluster constructed in a virtual private cloud environment. The system utilizes a physical server group including a plurality of multi-core CPUs, a large-capacity RAM, and a GPU specialized for parallel computing in order to execute software modules constituting each unit. The system receives a request from the outside via a load balancer, and distributes traffic to an appropriate server node. The system adopts a hybrid configuration of a relational database excellent in transaction processing and a NoSQL database excellent in high-speed search of unstructured data as the database management unit. The system implements a standard protocol such as OAuth or OpenID Connect in the user authentication unit, and issues a JSON Web Token to perform stateless session management. The system arranges an API gateway in the external linkage unit, and executes rate limit control and payload format conversion. This configuration exerts technical effects of optimal allocation of hardware resources, establishment of a secure communication path, and reduction of latency of inter-system linkage. The system enables future function addition and AI model update to be performed without stopping by loosely coupling each unit. The system is optimized for an enterprise-level use case in which the system is seamlessly integrated with a system of each base in a manufacturing network deployed on a global scale, and processes a huge amount of data in real time.

The idea receiving unit enables an on-site employee and an engineer to submit an improvement point and a new proposal noticed during daily work and robot operation from various devices such as a PC, a tablet, a smartphone, and a dedicated terminal in a factory, and receives a proposal for any on-site problem and room for improvement, such as optimization of an operation pattern of a collaborative robot, an automation algorithm of picking work, introduction of abnormality detection AI, energy-saving operation scheduling, a wear prediction model of a robot arm, enhancement of safety control during collaboration with a worker, redesign of a line layout, an automation proposal of maintenance and inspection, improvement of an inter-robot communication protocol, and a visualization dashboard proposal of on-site data. The idea receiving unit receives extremely diverse data such as a title, a detailed explanation, a related material (an on-site drawing, a work video, a sensor log, a simulation result, an external technical material, a reference paper URL, a patent document number, etc.), submitter information (an employee ID, an affiliated line, a process in charge, a job title, contact information, etc.), a submission date and time, a related project name, an expected effect (a productivity improvement rate, a cost reduction amount, a defective product rate reduction, the number of safety incident reductions, an energy consumption reduction amount, etc.), a problem and a risk, and reference external information, and also realizes version management of submission content, automatic search and presentation of a similar idea, a preview before submission, editing and postscript after submission, automatic tagging to the submission content, time-series management of a submission history, multilingual automatic translation of the submission content, an anonymous submission function, automatic summarization of the submission content, and the like. Specifically, the idea receiving unit includes a dedicated API endpoint that receives multipart form data from a client terminal. The system classifies the received data by type, and routes text data to a natural language processing pipeline, image data to a computer vision pipeline, and video data to a frame extraction process. The system utilizes an embedding model that tokenizes text and maps it to a high-dimensional vector space for similar idea search. Input data to the AI model includes, for example, a character string indicating proposal content which is text, a 3-channel RGB tensor of 224 pixels square which is an image, and an image tensor array for 30 frames which is a video. Output data from the AI model includes a parsing result in a JSON format, for example, which is a normalized data structure, and a floating-point number from 0 to 1 indicating a cosine similarity with a past proposal, for example, which is a similarity score. The system utilizes this output result in subsequent processing. The processing unit executes branch processing of displaying a warning screen of a duplicate proposal to a user when the similarity score exceeds a predetermined threshold. The system searches for a similar proposal in milliseconds from millions of past data using an approximate nearest neighbor search algorithm. This configuration exerts technical effects of reducing a load of subsequent processing by standardizing input data and saving storage capacity by eliminating a duplicate proposal. The system ensures data quality while saving time and effort for input in a use case where an on-site worker uploads a video shot from a smartphone as it is, and the system automatically extracts a feature and registers it in a database.

The automatic evaluation index calculation unit analyzes an explanatory text and an attached material of the submitted idea from multiple viewpoints using generative AI, extracts a gist and a technical feature of the proposal by natural language processing, specifies a keyword and a logical structure such as operation optimization by AI, sensor data utilization, and a safety enhancement measure, for example, combines image analysis and time-series data analysis, and automatically extracts a change in an operation pattern, a sign of abnormality occurrence, a relative positional relationship between a worker and a robot, a bottleneck in a process, an operation rate transition of the robot, an abnormal stop frequency, an interference status between a flow line of the worker and a robot operation, and the like from an attached on-site video and sensor log. Furthermore, it collates them with internal and external knowledge bases, a past improvement case, an industry technology trend, patent information, an academic paper, on-site operation record data, external safety standard information, and the like, scores them on a 10-point scale for each viewpoint of innovativeness, feasibility, productivity/quality impact, and safety, and automatically generates a basis for each viewpoint. For example, it performs various analyses such as analyzing an acceleration change of the robot arm from the sensor log to detect wear and an abnormality sign, extracting the flow line of the worker and the operation pattern of the robot from the on-site video to specify a safety risk and room for efficiency improvement, quantitatively evaluating a cycle time reduction effect at the time of introducing a new algorithm from the simulation result, and determining the presence or absence of a similar technology and novelty from an external technical material and a patent document. A specific example of a prompt sentence to be read by the generative AI includes “Analyze the following robot operation improvement proposal, evaluate it on a 10-point scale from four viewpoints of innovativeness, feasibility, productivity/quality impact, and safety, and calculate a total evaluation score together with a basis for each viewpoint. Proposal explanatory text: ‘Optimize an operation pattern of a robot collaborating with a worker using AI to improve efficiency and safety of picking work. A sensor log and an on-site video are attached.’”. Specifically, the automatic evaluation index calculation unit includes a multimodal transformer model having a cross-attention mechanism of text and image. The system converts various preprocessed data into a tensor format, and inputs it to the AI model. Input data to the AI model includes, for example, an integer ID array obtained by dividing a proposal sentence which is a text token sequence, a 2048-dimensional vector extracted from a convolutional neural network which is an image feature vector, and a one-dimensional array of 3-axis acceleration sampled at 100 hertz which is time-series sensor data. The AI model projects these heterogeneous data into a common latent space, and calculates a correlation between respective modalities. Output data from the AI model includes a floating-point number indicating innovativeness 8.5, for example, which is a score of each evaluation viewpoint, and a character string “because a novel algorithm is used”, for example, which is a basis text. The system utilizes this output result in subsequent processing. The processing unit calculates a weighted average of each score to calculate a total evaluation score, and updates an evaluation table of the database. The system executes supervised learning using past evaluation data by an expert as teacher data, and optimizes a weight parameter of the AI model using a mean square error function. This configuration exerts technical effects of improving evaluation accuracy by integrated analysis of multimodal data and dramatically reducing processing time by substituting manual evaluation by a human. The system eliminates a bottleneck in an examination process in a use case of instantly analyzing an attached simulation log for a proposal of a complex robot control algorithm and objectively scoring technical validity.

The work performance integration unit automatically collects extremely diverse performance data such as a productivity index (the number of processing per hour, in-process work efficiency), a quality control score (defective product rate, in-process inspection pass rate), a safety compliance rate (the number of accident-free days, the number of near-miss reports), a past commendation history (work improvement commendation, quality improvement commendation, safety commendation), a skill-up training attendance history (AI technology training, robot maintenance course, on-site safety education), a leader experience on site, a participation history in an on-site improvement activity, an on-site communication score, an evaluation by others on site, an inter-site transfer history, and a multi-skilled worker degree on site of an on-site employee and an engineer, and integrates them with an idea evaluation score by AI to calculate an overall contribution degree. For example, when a worker maintaining high productivity and a high safety compliance rate on site makes an excellent proposal, the overall contribution degree becomes high, and the priority of a reward and a commendation also increases. A weighting pattern is customizable according to a policy of a site or an organization, and is automatically adjusted according to an evaluation policy such as an innovation-oriented type, a safety-oriented type, a quality-oriented type, and an on-site contribution-oriented type. The AI also learns a past contribution tendency and a growth curve of the employee, and can also realize future potential evaluation, automatic extraction of a promotion candidate, an optimal personnel allocation proposal on site, and the like. Specifically, the work performance integration unit includes a prediction model based on a gradient boosting decision tree or a multilayer perceptron. The system executes missing value completion and normalization processing on various indices collected from the database to generate a feature vector. Input data to the AI model includes a 50-dimensional numerical vector including each score of productivity, quality, and safety, for example, which is a feature vector obtained by concatenating various performance indices. The AI model learns a non-linear decision boundary, and performs scoring in consideration of an interaction of each feature. Output data from the AI model includes 78.5 which is a continuous value in a range of 0 to 100, for example, which is an overall contribution degree score, and a floating-point number of 0.85 indicating a promotion probability, for example, which is a future potential prediction score. The system utilizes this output result in subsequent processing. The processing unit generates a ranking list of employees based on the calculated score, and transfers data to a reward design module. The system dynamically recalculates a weighting parameter for each feature by matrix calculation according to a change in the evaluation policy. This configuration exerts technical effects of stabilizing calculation by normalizing and integrating heterogeneous data, and improving objectivity and accuracy of personnel evaluation by introducing a prediction model. The system dramatically increases a utilization level of personnel data in a use case of integrating a daily work record of an individual and a contribution degree to innovation in real time and automatically proposing optimal personnel allocation in a large-scale factory to which thousands of employees belong.

The visualization display unit displays evaluation data and performance data on a dashboard in various formats, and provides extremely diverse visualization patterns such as an evaluation transition graph for each proposal, an idea submission number ranking by site and by worker, a heat map of an overall contribution degree, a radar chart by evaluation item, a progress Gantt chart of an improvement proposal, an innovation tendency analysis graph of the entire site, a safety score transition for each site, communication network visualization on site, an idea distribution map between sites, a commendation history distribution for each site, and a skill map for each site. An administrator can grasp at a glance what kind of proposal is frequent at which site, which worker contributes to innovation, which evaluation item is weak in the entire organization, a knowledge distribution status between sites, a maturity degree of a safety culture for each site, and the like. The employee himself/herself can browse his/her own evaluation status, feedback history, past submission history, his/her own positioning on site, and information that can be utilized for self-growth and career formation. Specifically, the visualization display unit is composed of a front-end application and a back-end data streaming server. The system detects an update event in the database, and push-distributes difference data to a client terminal using a WebSocket protocol. The system executes efficient rendering processing using a virtual DOM on the client side, and minimizes a screen redrawing cost. The processing unit converts high-dimensional skill map data into two-dimensional coordinates using a principal component analysis algorithm, and draws it as a scatter plot. The system executes a layout algorithm based on a dynamic model in drawing a network graph, and avoids overlapping between nodes. The visualization display unit adopts a responsive design, and dynamically calculates an optimal layout according to a resolution of a device from a large monitor of a PC to a small screen of a smartphone. This configuration exerts a technical effect of reflecting real-time data update on a screen while suppressing consumption of a network bandwidth. The system provides an interactive operation of asynchronously fetching related detailed data and performing drill-down display when the administrator clicks a specific graph element on the dashboard. The system visually organizes a huge amount of information and enables intuitive situation grasping in a use case where a factory manager projects data on a large display in a control room overlooking an innovation status of all bases.

The reward design unit performs multivariate analysis on an overall contribution degree, a past commendation history, a motivation tendency of an employee and an engineer, an on-site reward policy, a budget status, a career orientation, a past incentive response, a leader experience on site, a participation history in an on-site improvement activity, a personnel allocation status on site, a reward history distribution for each site, and the like using generative AI, and automatically designs various reward and commendation plans according to an on-site and individual orientation, such as a special commendation, a monetary reward, selection as an on-site improvement project leader, a right to participate in joint development with a robot maker, granting of skill certification points, a right to participate in skill-up training, introduction in internal public relations, an on-site event invitation, an inter-site transfer recommendation, granting of authority to launch a new project on site, and an on-site mentor role recommendation. A specific example of a prompt sentence to be read by the generative AI includes “Design an optimal reward and commendation plan in consideration of an overall contribution degree, a past commendation history, a motivation tendency, and an on-site reward policy of an employee X. Explain proposal content together with a basis.”. Specifically, the reward design unit inputs a context dynamically constructed using a prompt engineering technology to a large language model. The system serializes structured data acquired from the database into a character string in a JSON format, and inserts it into a placeholder of a prompt template. Input data to the AI model includes, for example, a scalar value 92 which is an overall contribution degree, an array of past commendation IDs, for example, which is a past commendation history, and a vector obtained by digitizing a questionnaire result, for example, which is a motivation tendency. The AI model calculates a dependency relationship between respective elements in an input sequence using a self-attention mechanism, and infers an optimal reward plan. Output data from the AI model includes a numerical array indicating a special commendation 0.7, a monetary reward 0.2, and training participation 0.1, for example, which is a probability distribution for each reward plan, and a character string “We propose a special commendation in evaluation of high contribution and leadership”, for example, which is a generated explanatory text. The system utilizes this output result in subsequent processing. The processing unit selects a plan having a maximum value of the probability distribution, and transmits data to an approval workflow system. The system verifies whether the output text matches a predetermined format using a regular expression, and executes regeneration processing by adjusting a temperature parameter when a parsing error occurs. This configuration exerts a technical effect of searching for an optimal solution satisfying various constraint conditions without describing a rule-based program accompanied by complex conditional branching. The system dramatically reduces a work load of a human resources department in a use case of automatically generating a reward portfolio that maximizes motivation of an employee within a limited budget.

The feedback generation unit automatically generates a specific improvement proposal and action plan based on an evaluation result by AI, such as that feasibility of an operation pattern optimization plan increases by analyzing on-site sensor data in more detail, that it is recommended to implement an additional risk assessment to enhance safety evaluation, that additional learning data collection is effective for improving accuracy of an abnormality detection algorithm, that an effect of an energy-saving operation proposal is maximized by linking it with an on-site operation schedule, that an implementation cost can be suppressed by promoting collaboration with another department on site, and that safety improvement can be expected by linking it with an on-site worker education program, and distributes them to a worker and an engineer. Feedback is distributed through a plurality of channels such as a dashboard, an email notification, chatbot linkage, on-site bulletin board linkage, and automatic generation of an on-site morning assembly material, and also learns a past response and improvement history of an employee to evolve into more personalized content. A specific example of a prompt sentence to be read by the generative AI includes “Generate a specific improvement proposal and a future action plan for an employee based on the following evaluation result. Evaluation result: innovativeness 9 points, feasibility 6 points, productivity/quality impact 8 points, safety 7 points.”. Specifically, the feedback generation unit inputs a past excellent feedback example included in a context to a large language model using a Few-shot prompting method. Input data to the AI model includes an array including a score of each item, for example, which is an evaluation result vector, coordinate data on a high-dimensional space, for example, which is an embedding vector of a proposal text, and a past feedback history vector. The AI model focuses on an input item with a low score, searches a knowledge base for a specific action for improving the item, and generates text. Output data from the AI model includes a character string “It is recommended to extend a data collection period”, for example, which is a text token sequence of an improvement proposal, and a selection probability vector of a distribution channel. The system utilizes this output result in subsequent processing. The processing unit converts the generated text into an API format of each distribution channel, and registers transmission processing in a distributed task queue as an asynchronous task. The system internally evaluates quality of the generated text using a BLEU score and a ROUGE score, and performs regeneration when a quality standard is not satisfied. This configuration exerts a technical effect of eliminating time for a human to manually draft a feedback sentence and allowing the system to autonomously generate high-quality text. The system functions extremely effectively in a use case of preventing a decrease in motivation of an employee by automatically presenting a reason and a specific step toward next improvement even when a proposal is rejected.

The progress reporting unit distributes a quantitative progress and effect prediction as a report to a related party, such that AI analyzes an evaluation status of a proposal, progress of on-site introduction, and a prediction of a business impact, that an operation optimization proposal is currently in an on-site test stage, and a 15% improvement in picking work efficiency and a 20% reduction in a safety incident occurrence rate are expected in an initial evaluation, that an abnormality detection AI introduction plan requires additional examination because a technical problem of system linkage remains, that an energy-saving operation proposal is expected to reduce monthly energy consumption by 10%, that simultaneous introduction is in progress in a plurality of lines on site, and an effect comparison between lines is also automatically aggregated, and that a safety improvement measure linked with an on-site worker education program is in progress. A progress report is distributed to various related parties such as an on-site manager, a management layer, a related department, and an external partner by automatically adjusting browsing authority and reporting granularity. A specific example of a prompt sentence to be read by the generative AI includes “Predict a future business impact based on a progress status and an evaluation history of the following idea, and generate a progress report for a related party.”. Specifically, the progress reporting unit includes a neural generation model that executes a data-to-text conversion algorithm. The system converts structured data acquired from the database into a flat list of key-value pairs, and inputs it to the AI model. Input data to the AI model includes, for example, a time-series status ID array which is a past progress log, a current status flag, and an initial prediction value of a business impact. The AI model analyzes a tendency of input numerical data, and generates a fluent report text according to a grammar rule of natural language. Output data from the AI model includes a numerical value indicating a cost reduction amount, for example, which is a future business impact prediction value, and a character string “It is expected to achieve a target next month”, for example, which is a report text. The system utilizes this output result in subsequent processing. The processing unit renders the generated report from an HTML format to a PDF format, and automatically transmits it to an email address of a related party using an SMTP protocol. The system generates expressive text while ensuring numerical accuracy by combining a template-based generation method and a neural generation method in a hybrid manner. This configuration exerts technical effects of completely automating routine report creation work and realizing real-time information sharing using computer resources. The system significantly reduces a management cost in a use case of integrating a status of each project and automatically generating a summary report for a management layer on a daily basis in a large-scale manufacturing site where a plurality of projects proceed in parallel.

The database management unit centrally manages all idea data, evaluation data, performance data, reward history, feedback history, progress data, user information, on-site information, external linkage data, and the like, and is responsible for data consistency, security, backup, access authority management, data mining, history management, provision of a data linkage API, and the like. The user authentication unit performs user authentication using an employee ID, a password, biometric authentication, two-step authentication, and the like at the time of access from a terminal, and controls a browsable and editable data range according to access authority. The external linkage unit links with an external knowledge base, a market database, an industry news API, an external evaluator interface, an external reward service, an external personnel system, a technical information API of a robot maker, an external safety standard database, and the like to ensure expandability and flexibility of the system. Specifically, the database management unit constructs a replication cluster of a master-slave configuration, and distributes a read query to a slave node, thereby reducing a load on a database. The system caches frequently accessed data in an in-memory data store such as Redis, and eliminates a bottleneck of disk I/O. The user authentication unit hashes and stores a password with a Bcrypt algorithm, and encrypts an entire communication path with a TLS 1.3 protocol. The system issues a JSON Web Token with an expiration date upon successful authentication, and includes it in a header of a subsequent API request, thereby realizing stateless authentication. The external linkage unit includes an API gateway based on a RESTful architecture, and executes rate limit control and IP address-based filtering for a request from an external system. The system parses data in an XML format acquired from an external API into a JSON format for internal processing, and absorbs a mismatch in data structure. This configuration exerts technical effects of improving a data search speed, preventing unauthorized access, and reducing latency of inter-system linkage. The system destroys a data silo and provides an integrated data infrastructure in a use case of safely and rapidly linking an internal legacy personnel system and the latest cloud-based AI evaluation system.

As described above, in the system according to the present embodiment, each unit cooperates to comprehensively and efficiently realize a series of processes for maximizing on-site-led innovation promotion and human resource utilization in a factory robot field, such as various idea submissions by an on-site employee and an engineer, advanced automatic evaluation by generative AI, integration with work performance, visualization, optimal reward design, specific feedback generation, progress reporting, data management, user authentication, and external linkage. Specifically, in the system, each component operates as an independent process, and mutually cooperates based on an event-driven architecture. The system publishes an event that an idea has been submitted to a message broker, and an evaluation module and a notification module subscribe to the event and asynchronously start processing. This configuration ensures scalability that does not impair responsiveness of the entire system even when specific processing takes time. The system completely reconstructs a conventional business process depending on human subjectivity and manual work by a combination of computer technologies of vector calculation of high-dimensional data, pattern recognition by a neural network, and parallel processing by a distributed system. The system achieves clear technical improvements of speeding up processing, ensuring objectivity of evaluation, and real-time processing of a huge amount of data by this reconstruction. The system functions not merely as a business efficiency improvement tool but as an advanced information processing apparatus in which hardware and software operate in close cooperation from data input to inference, output, and formation of a feedback loop. The system fundamentally strengthens competitiveness of a company in a use case of collecting and analyzing all on-site data and autonomously continuing to run an improvement cycle as a core infrastructure of digital transformation in a manufacturing industry.

### Implementation Steps

Step 1: Submission and Reception of On-site Proposal An on-site employee and an engineer input a proposal for any problem and room for improvement on site, such as optimization of an operation pattern of a collaborative robot, an automation algorithm for picking work, introduction of anomaly detection AI, energy-saving operation scheduling, a wear prediction model for a robot arm, enhancement of safety control during collaboration with a worker, redesign of a line layout, an automation proposal for maintenance and inspection, improvement of an inter-robot communication protocol, and a visualization dashboard proposal for on-site data, from various devices such as a PC, a tablet, a smartphone, and a dedicated terminal in a factory. A title, a detailed explanation, a related material (an on-site drawing, a work video, a sensor log, a simulation result, an external technical material, a reference paper URL, a patent document number, etc.), submitter information, a submission date and time, a related project name, an expected effect, a problem and a risk, external information serving as a reference, and the like are input, and a receiving unit transmits these data to a server by encrypted communication, and also realizes version management of submission content, automatic search and presentation of a similar idea, a preview before submission, editing and postscript after submission, automatic tagging to the submission content, time-series management of a submission history, multilingual automatic translation of the submission content, an anonymous submission function, automatic summarization of the submission content, and the like. Specifically, in this step, an application on a client terminal temporarily holds data input by a user in a memory, and executes validation processing of an input field. When detecting an input omission of an essential item or an error in a data format, the terminal immediately renders an error message. The terminal serializes the data that has passed the validation into a payload in a JSON format, and transmits the payload to the server as an HTTPS request encrypted using a TLS 1.3 protocol. Upon receiving the request, the receiving unit on the server side deserializes the payload and executes sanitization processing for preventing an attack such as cross-site scripting. The system divides an attached large-capacity video file and log data into chunks, and asynchronously uploads them to a distributed object storage. The system associates a unique URI issued after completion of the upload with a proposal record in a database and saves them. This configuration exerts technical effects of efficient use of a network bandwidth and prevention of a timeout error during large-capacity data transfer. The system prevents data loss and realizes reliable data collection in a use case where an on-site worker transmits a proposal with a video using a smartphone from a factory area with an unstable network environment.

Step 2: Multifaceted Automatic Evaluation by Generative AI An automatic evaluation index calculation unit analyzes an explanatory text and an attached material of a submitted idea in a multifaceted manner using generative AI. The generative AI extracts a gist and a technical feature of a proposal by natural language processing, specifies a keyword and a logical structure such as operation optimization by AI, sensor data utilization, and a safety enhancement measure, combines image analysis and time-series data analysis, and automatically extracts a change in an operation pattern, a sign of anomaly occurrence, a relative positional relationship between a worker and a robot, a bottleneck in a process, a transition of an operation rate of the robot, an abnormal stop frequency, an interference status between a flow line of the worker and a robot operation, and the like from an attached on-site video and sensor log. Furthermore, it collates them with internal and external knowledge bases, a past improvement case, an industry technology trend, patent information, an academic paper, on-site operation record data, external safety standard information, and the like, scores them on a 10-point scale for each viewpoint of innovativeness, feasibility, productivity/quality impact, and safety, and automatically generates a basis for each viewpoint. As a specific example of a prompt sentence to be read by the generative AI, “Analyze the following robot operation improvement proposal, evaluate it on a 10-point scale from four viewpoints of innovativeness, feasibility, productivity/quality impact, and safety, and calculate a total evaluation score together with a basis for each viewpoint. Proposal explanatory text: ‘Optimize an operation pattern of a robot collaborating with a worker by AI to improve efficiency and safety of picking work. A sensor log and an on-site video are attached.’” and the like can be cited. Specifically, in this step, the automatic evaluation index calculation unit activates an inference pipeline deployed on a GPU cluster. The system supplies input data to an AI model by batch processing or stream processing. The input data to the AI model includes a text token sequence, an image feature amount vector, and time-series sensor data. The AI model executes forward propagation calculation of a neural network having hundreds of millions of parameters, and extracts a feature representation of the input data. Output data from the AI model includes a score of each evaluation viewpoint and a basis text. The system uses this output result in subsequent processing. The processing unit calculates a weighted average of each score to calculate a total evaluation score, and updates an evaluation table in a database. The system uses model quantization and an optimization library for tensor calculation in order to speed up inference processing. This configuration exerts a technical effect of calculation efficiency improvement that completes analysis of complex multimodal data in milliseconds. The system maximizes throughput of an evaluation process in a use case where an objective score is immediately given to hundreds of improvement proposals submitted every day without intervention of a human examiner.

Step 3: Integration of Work Performance Data and Calculation of Overall Contribution Degree A work performance integration unit automatically collects extremely diverse performance data such as a productivity index (the number of processing per hour, in-process work efficiency), a quality control score (defective product rate, in-process inspection pass rate), a safety compliance rate (the number of accident-free days, the number of near-miss reports), a past commendation history (business improvement commendation, quality improvement commendation, safety commendation), a skill-up training attendance history (AI technology training, robot maintenance course, on-site safety education), a leader experience on site, a participation history in an on-site improvement activity, an on-site communication score, an evaluation by others on site, an inter-site transfer history, and a multi-skilled worker degree on site of an on-site employee and an engineer, and integrates them with an idea evaluation score by AI to calculate an overall contribution degree. A weighting pattern is customizable according to a policy of a site or an organization, and is automatically adjusted according to an evaluation policy such as an innovation-oriented type, a safety-oriented type, a quality-oriented type, and an on-site contribution-oriented type. Specifically, in this step, the work performance integration unit executes an extraction, transformation, and loading pipeline to aggregate information from distributed data sources. The system executes outlier removal using a statistical method and missing value complementation processing using a mean value complementation algorithm on the collected raw data. The system converts the preprocessed data into a multidimensional numerical matrix and deploys it on a memory. The processing unit reads a weighting vector based on the set evaluation policy from a database, and executes an inner product operation with the data matrix. By this matrix operation, the system calculates an overall contribution degree score of all employees collectively at high speed. This configuration exerts a technical effect of improving a processing speed by parallel operation utilizing a SIMD instruction of a CPU by eliminating sequential calculation by loop processing. The system significantly shortens an execution time of batch processing in a use case where performance data for thousands of people is instantaneously aggregated and an evaluation result is finalized on an evaluation closing date at the end of a month.

Step 4: Visualization of Evaluation/Contribution Degree and On-site Dashboard Display A visualization display unit displays evaluation data and performance data on a dashboard in various formats, and provides extremely diverse visualization patterns such as an evaluation transition graph for each proposal, an idea submission number ranking by site and by worker, a heat map of an overall contribution degree, a radar chart by evaluation item, a progress Gantt chart of an improvement proposal, an innovation tendency analysis graph of the entire site, a safety score transition for each site, communication network visualization within a site, an idea distribution map between sites, a commendation history distribution for each site, and a skill map for each site. An administrator can grasp at a glance what kind of proposal is frequent at which site, which worker contributes to innovation, which evaluation item is weak in the entire organization, a knowledge distribution status between sites, a maturity degree of a safety culture for each site, and the like. Specifically, in this step, the visualization display unit distributes the calculated overall contribution degree and evaluation data to a front-end application. When detecting an update of data, the system push-transmits only difference data to a client terminal through a WebSocket connection. A browser on the client terminal updates a virtual DOM tree based on the received JSON data, and executes a difference drawing algorithm that minimizes application to an actual DOM. The terminal utilizes background processing using a WebWorker so as not to block a main thread in drawing a complex graph. This configuration exerts a technical effect of preventing a freeze of the browser when rendering a graph including a large amount of data points and providing a smooth user interface. The system strongly supports motivation improvement on site and data-driven decision making in a use case where the latest innovation status is continuously fed back in real time and visually on a dashboard constantly displayed on a large monitor on site.

Step 5: Optimal Reward and Commendation Design by Generative AI A reward design unit performs multivariate analysis on an overall contribution degree, a past commendation history, a motivation tendency of an employee and an engineer, an on-site reward policy, a budget status, a career orientation, a past incentive response, a leader experience on site, a participation history in an on-site improvement activity, a human resource allocation status on site, a reward history distribution for each site, and the like using generative AI, and automatically designs various reward and commendation plans according to an on-site and individual orientation, such as a special commendation, a monetary reward, selection as an on-site improvement project leader, a right to participate in joint development with a robot maker, granting of skill certification points, a right to participate in skill-up training, introduction in internal public relations, an on-site event invitation, an inter-site transfer recommendation, granting of authority to launch a new project on site, and an on-site mentor role recommendation. As a specific example of a prompt sentence to be read by the generative AI, “Design an optimal reward and commendation plan in consideration of an overall contribution degree, a past commendation history, a motivation tendency, and an on-site reward policy of an employee X. Explain proposal content together with a basis.” and the like can be cited. Specifically, the reward design unit receives attribute data and evaluation data of an employee as an input. The reward design unit converts the input data into a multidimensional vector. The multidimensional vector includes, for example, a floating-point value indicating the overall contribution degree, a one-hot encoding array indicating the past commendation history, an embedding vector of a natural language text indicating the motivation tendency, and the like. The reward design unit holds a hybrid neural network combining a large language model and a multilayer perceptron. The hybrid neural network adopts a transformer architecture provided with a self-attention mechanism. The reward design unit inputs the multidimensional vector to the hybrid neural network. The hybrid neural network maps the input vector to a high-dimensional feature space. The hybrid neural network calculates a probability distribution of an optimal reward plan through a non-linear operation in the feature space. The hybrid neural network generates a score array for a plurality of reward candidates as output data. The output data includes, for example, a score of 0.85 indicating a recommendation degree of a special commendation, a score of 0.92 indicating a recommendation degree of monetary reward granting, a score of 0.76 indicating a recommendation degree of selection as a project leader, and the like. The reward design unit applies a softmax function to the output score array. The reward design unit extracts a reward plan having a score exceeding a threshold as a final candidate. The reward design unit transmits the extracted reward plan to a subsequent approval flow processing module. With this configuration, the system realizes objective and highly accurate reward design that does not depend on human subjectivity. The system significantly shortens a calculation time by processing multivariate analysis in parallel. The system brings about technical effects of improving employee motivation and reducing a turnover rate. This is because the system accurately captures a potential career orientation of an individual in a high-dimensional space and dynamically allocates an optimal incentive. This technology is applicable to a use case such as a personnel evaluation system in a large-scale manufacturing industry and a performance management system of a software development team. The system also includes a variation in which a performance change after past reward granting is learned as a reward signal using reinforcement learning, and a weight of a model is continuously updated. The system minimizes a loss during learning using a cross-entropy error function. The system optimizes a parameter of a network by a gradient descent method. The system solves a technical problem of optimizing dynamic resource allocation by improving a data processing structure inside a computer, rather than mere business efficiency improvement.

Step 6: Feedback and Improvement Proposal Generation by Generative AI A feedback generation unit automatically generates a specific improvement proposal and an action plan, such as that feasibility of an operation pattern optimization proposal increases by analyzing on-site sensor data in more detail, that implementation of an additional risk assessment is recommended to enhance safety evaluation, that additional learning data collection is effective for accuracy improvement of an anomaly detection algorithm, that an effect of an energy-saving operation proposal is maximized by linking it with an on-site operation schedule, that an implementation cost can be suppressed by promoting collaboration with another department on site, and that safety improvement can be expected by linking it with an on-site worker education program, based on an evaluation result by AI, and distributes them to a worker and an engineer. As a specific example of a prompt sentence to be read by the generative AI, “Generate a specific improvement proposal and a future action plan for an employee based on the following evaluation result. Evaluation result: innovativeness 9 points, feasibility 6 points, productivity/quality impact 8 points, safety 7 points.” and the like can be cited. Specifically, the feedback generation unit acquires an evaluation score array and basis text data output from an automatic evaluation index calculation unit. The feedback generation unit converts the acquired data into a structured prompt tensor. The structured prompt tensor includes, for example, numerical data of an innovativeness score, flag data indicating low feasibility, a text embedding vector regarding safety, and the like. The feedback generation unit holds a large language model specialized for natural language generation. The large language model is a pre-trained transformer model having billions of parameters. The feedback generation unit inputs the structured prompt tensor to the large language model. The large language model processes the input tensor by a decoder network. The large language model sequentially calculates a token probability distribution according to a context. The large language model outputs a natural language text indicating a specific improvement action and a priority score as output data. The output data includes, for example, a text prompting additional analysis of sensor data, a bulleted text indicating an implementation procedure of a risk assessment, a text indicating a specific method of learning data collection, and the like. The feedback generation unit inputs the output text data to a syntax analysis module. The syntax analysis module extracts a specific task item from the text. The feedback generation unit registers the extracted task item in a subsequent task management database. With this configuration, the system completely automates feedback generation processing for a proposer. The system equalizes the quality of feedback and eliminates individual variation. The system exerts a technical effect of iteratively increasing feasibility of a proposal. This is because the system dynamically combines and presents an optimal improvement measure extracted from a past success case database for an item with a low evaluation score. This technology is applicable to a use case such as an improvement proposal system at a manufacturing site and a code review automation system in software development. The system uses a reaction history of a proposer to the generated feedback as a feedback loop. The system also includes a variation in which a model is fine-tuned to text generation that further promotes behavior modification by adjusting a reward function of reinforcement learning. The system dynamically changes a parameter of a beam search algorithm during text generation to generate diverse expressions. The system is an improvement of computer technology that generates a novel information structure through a probabilistic operation in a high-dimensional language space, rather than substituting human mental activity.

Step 7: Progress Reporting and Impact Prediction by Generative AI A progress reporting unit distributes a quantitative progress and effect prediction as a report to a related party, such as that AI analyzes an evaluation status of a proposal, progress of on-site introduction, and a prediction of a business impact, that an operation optimization proposal is currently in an on-site test stage, and a 15% improvement in picking work efficiency and a 20% reduction in a safety incident occurrence rate are expected in an initial evaluation, that an anomaly detection AI introduction proposal requires additional examination because a technical problem of system linkage remains, that an energy-saving operation proposal is expected to reduce monthly energy consumption by 10%, that simultaneous introduction is in progress in a plurality of lines on site, and an effect comparison between lines is also automatically aggregated, and that a safety improvement measure linked with an on-site worker education program is in progress. As a specific example of a prompt sentence to be read by the generative AI, “Predict a future business impact based on a progress status and an evaluation history of the following idea, and generate a progress report for a related party.” and the like can be cited. Specifically, the progress reporting unit acquires time-series operation log data and project management data from a plurality of on-site systems. The progress reporting unit preprocesses the acquired data into time-series tensor data. The time-series tensor data includes, for example, a transition array of a picking work time for the past 30 days, a time-series vector of the number of safety incident occurrences, continuous data of energy consumption, and the like. The progress reporting unit holds a prediction model combining a long short-term memory network and a graph convolutional network. The progress reporting unit inputs the time-series tensor data to the prediction model. The prediction model performs regression prediction of a future performance index from a past trend. The prediction model outputs a predicted numerical value and a confidence interval at a specific future time point as output data. The output data includes, for example, a numerical value of 15 percent indicating a work efficiency improvement rate after three months, a numerical value of 20 percent indicating an incident reduction rate, a numerical value of 10 percent indicating an energy reduction amount, and the like. The progress reporting unit inputs these predicted numerical values to a large language model. The large language model generates a natural language report text based on the predicted numerical values. The progress reporting unit transfers the generated report text to a subsequent distribution server. The distribution server push-notifies the report to a terminal of a related party. With this configuration, the system realizes real-time data-driven progress management. The system detects a delay risk of a project at an early stage and automates reallocation of resources. The system brings about a technical effect of dramatically improving prediction accuracy of a business impact. This is because the system models a non-linear interaction woven by a plurality of related variables by a graph neural network, rather than mere linear interpolation. This technology is applicable to a use case such as an operation management system of a large-scale plant and progress monitoring of an infrastructure development project in a smart city. The system also includes a variation in which a prediction error is calculated by a mean square error function, and a weight of a prediction model is periodically updated using an error backpropagation method. The system applies dropout processing to an input layer in order to perform robust prediction on input data including an abnormal value. The system executes processing peculiar to a computer, which is calculation of a future state based on dynamic analysis of high-dimensional time-series data, rather than mere aggregation of information.

### Specific Use Case

For example, a case is assumed where an on-site employee submits a proposal from a terminal to optimize an operation pattern of a collaborative robot by AI and improve efficiency and safety of picking work in an assembly line of a factory. At this time, an idea receiving unit receives a title “Improvement of Picking Efficiency by Operation Optimization of Collaborative Robot”, a detailed explanation “In current picking work, an operation pattern of a robot partially overlaps with a flow line of a worker, and a decrease in work efficiency and a safety risk occur. By introducing an operation pattern optimization algorithm by AI and analyzing a sensor log and an on-site video, the flow line of the worker and the operation of the robot are automatically optimized, and efficiency improvement and safety improvement are simultaneously realized.”, an on-site layout drawing, a work video, a sensor log, and a simulation result as related materials, submitter information, a submission date and time, a related project name “Assembly Line DX”, an expected effect “10% reduction in picking work cycle time, 30% reduction in safety incident occurrence rate”, a problem “availability of linkage with existing control system on site”, and the like, and records them in a database on a server side. The receiving unit automatically searches for a similar idea such as “picking work automation” and “robot operation safety improvement” submitted in the past, and presents it to the employee as reference information. Specifically, the idea receiving unit receives a multimodal data packet transmitted from the terminal. The multimodal data packet is a composite data structure including text data, image data, video data, and time-series numerical data. The idea receiving unit parses the received data packet, and executes preprocessing according to each data type. The idea receiving unit converts the text data into a word embedding vector. The idea receiving unit inputs the image data of the on-site layout drawing to a convolutional neural network, and extracts a spatial feature tensor. The idea receiving unit inputs the work video data to a three-dimensional convolutional neural network, and extracts a spatiotemporal feature tensor. The idea receiving unit normalizes the sensor log data, and converts it into time-series array data. The idea receiving unit combines these feature tensors to generate a single high-dimensional proposal vector. The idea receiving unit stores the generated high-dimensional proposal vector in a vector database. The idea receiving unit executes a similarity search algorithm. The idea receiving unit calculates a cosine similarity between the input high-dimensional proposal vector and an existing idea vector in the database. The idea receiving unit extracts an existing idea having a cosine similarity exceeding a predetermined threshold as a similar idea. The idea receiving unit returns metadata of the extracted similar idea to the terminal. With this configuration, the system processes input data in various formats in a unified vector space. The system extracts a past proposal having a potential similarity that cannot be discovered by a text search with high accuracy. The system brings about technical effects of preventing a duplicate proposal and promoting reuse of existing knowledge. This is because the system makes it possible to compare not only a superficial keyword of a proposal but also a technical essential structure by using a multimodal feature representation. This technology is applicable to a use case such as a research and development knowledge management system and a patent prior art search system in a manufacturing industry. The system also includes a variation in which a search is completed in milliseconds even for a database of millions of cases by using an approximate nearest neighbor search algorithm. The system executes processing unique to a computer, which is mapping of multimodal data to a high-dimensional space and a high-speed geometric operation, rather than mere data saving.

The automatic evaluation index calculation unit analyzes the submitted explanatory text and attached materials using generative AI. The generative AI extracts keywords such as “operation optimization by AI”, “sensor data utilization”, and “safety enhancement” by natural language processing, and automatically extracts flow line overlapping points of a worker and a robot, an operation rate transition, an abnormal stop frequency, and the like from an on-site video and a sensor log. Further, it collates them with internal and external knowledge bases, past improvement cases, industry technology trends, patent information, academic papers, on-site operation record data, external safety standard information, and the like, scores them on a 10-point scale for each viewpoint of innovativeness, feasibility, productivity/quality impact, and safety, and automatically generates a basis for each viewpoint. For example, it presents specific analysis results such as “Compared with existing collaborative robot operation cases, the operation pattern optimization method is novel, and the safety enhancement measure utilizing on-site sensor data is also highly unique”, “Compatibility between the on-site robot control system and the existing AI algorithm is high, and the introduction cost is within an allowable range”, “A cycle time reduction effect of picking work is confirmed to be 10% by simulation”, and “An interference risk between the flow line of the worker and the robot operation is reduced”. Specific examples of a prompt sentence to be read by the generative AI include “Analyze the following robot operation improvement proposal, evaluate it on a 10-point scale from four viewpoints of innovativeness, feasibility, productivity/quality impact, and safety, and calculate a total evaluation score together with a basis for each viewpoint. Proposal explanatory text: ‘Optimize an operation pattern of a collaborative robot by AI to improve efficiency and safety of picking work. Sensor log and on-site video are attached.’”, and the like. Specifically, the automatic evaluation index calculation unit acquires a high-dimensional proposal vector and raw multimodal data from the idea receiving unit. The automatic evaluation index calculation unit holds a vision transformer model for video analysis. The automatic evaluation index calculation unit inputs on-site video data to the vision transformer model. The vision transformer model calculates an optical flow between video frames, and extracts skeleton coordinate data of the worker and end effector trajectory data of the robot. The automatic evaluation index calculation unit executes a spatial intersection determination operation of the extracted coordinate data group, and generates a heat map tensor of the flow line overlapping points. The automatic evaluation index calculation unit inputs sensor log data to an anomaly detection autoencoder, and calculates a time-series vector of the abnormal stop frequency from a reconstruction error. The automatic evaluation index calculation unit integrates these analysis results and the proposal text, and inputs them to a large language model. The large language model adopts a retrieval-augmented generation architecture. The large language model issues a query to an external patent database or academic paper database based on the input data, and acquires a related technical document vector. The large language model compares and collates the acquired technical document vector and the proposal data by a self-attention mechanism. The large language model outputs a score array and a basis text for the four evaluation viewpoints as output data. The output data includes, for example, a numerical array of an innovativeness score of 8.5, a feasibility score of 7.2, a productivity score of 9.0, and a safety score of 8.8. The automatic evaluation index calculation unit transmits the output score array to the subsequent work performance integration unit. With this configuration, the system realizes instantaneous collation with a vast amount of external knowledge, which is impossible for a human examiner. The system automatically extracts a quantitative evaluation basis from unstructured data such as a video and sensor data. The system brings about technical effects of improving objectivity of evaluation and dramatically speeding up an examination process. This is because the system verifies technical validity of the proposal content based on multifaceted data sources by combining multimodal feature extraction and retrieval-augmented generation. The present technology is applicable to use cases such as an investment project evaluation system of a venture capital and a grant examination system of public research funds. The system also includes a variation of performing uncertainty estimation on the output of the evaluation model and setting a flag requesting a review by a human expert when reliability is low. The system does not imitate human mental judgment, but executes computer-specific data processing based on high-dimensional tensor operations and large-scale vector retrieval.

The work performance integration unit automatically collects productivity indices (e.g., the number of pickings per hour), quality control scores (e.g., a defective product rate, an in-process inspection passing rate), safety compliance rates (e.g., the number of accident-free days, the number of near-miss reports), past commendation histories (e.g., a business improvement commendation, a quality improvement commendation, a safety commendation), skill-up training attendance histories (e.g., AI technology training, robot maintenance training, on-site safety education), and the like of the employee, and integrates them with the idea evaluation score by the AI to calculate an overall contribution degree. For example, when a worker who maintains high productivity and a high safety compliance rate on site makes an excellent proposal, the overall contribution degree becomes high, and the priority of a reward and a commendation also increases. Specifically, the work performance integration unit acquires employee performance data from a plurality of internal core systems by asynchronous communication. The work performance integration unit normalizes the acquired heterogeneous data, and generates a performance feature vector for each employee. The performance feature vector includes, for example, a normalized numerical value indicating the productivity index, a percentage value indicating the quality control score, a continuous value indicating the safety compliance rate, a binary array indicating the commendation history, and the like. The work performance integration unit acquires the idea evaluation score array received from the automatic evaluation index calculation unit. The work performance integration unit combines the performance feature vector and the idea evaluation score array to generate an integrated feature tensor. The work performance integration unit holds an integrated evaluation model based on a gradient boosting decision tree algorithm. The work performance integration unit inputs the integrated feature tensor to the integrated evaluation model. The integrated evaluation model evaluates a non-linear interaction of each feature amount through ensemble learning of a plurality of decision trees. The integrated evaluation model outputs an overall contribution degree score taking a continuous value from 0 to 100 as output data. The output data is, for example, numerical data such as an overall contribution degree score of 88.5 for employee A and an overall contribution degree score of 72.3 for employee B. The work performance integration unit transmits the calculated overall contribution degree score to the subsequent visualization display unit and reward design unit. With this configuration, the system integrates distributed human resource data and business data into a single evaluation axis. The system eliminates data silos and automates comprehensive human resource evaluation. The system brings about technical effects of ensuring fairness of evaluation and improving efficiency of calculation processing. This is because the system eliminates manual data aggregation and dynamically adjusts the importance of each index through weighting optimization by a machine learning model. The present technology is applicable to use cases such as an operator evaluation system of a large-scale call center and a worker performance management system of a logistics warehouse. The system also includes a variation of executing supervised learning using past promotion data and a project success rate as objective variables in learning of the integrated evaluation model. The system has a function of calculating the importance of the feature amount as a SHAP value and making the calculation basis of the overall contribution degree score explainable. The system provides an improvement in computer technology of dynamic feature amount weighting based on machine learning, rather than mere application of a calculation formula.

The visualization display unit displays evaluation data and performance data on a dashboard, and provides, for example, an evaluation transition graph of a “collaborative robot operation optimization proposal”, an idea submission number ranking by site and by worker, a heat map of the overall contribution degree, a radar chart by evaluation item, a progress Gantt chart of an improvement proposal, and the like. An administrator can grasp at a glance what kind of proposals are frequent at which site and which worker is contributing to innovation. Specifically, the visualization display unit acquires various score data and prediction data output from the work performance integration unit and the progress reporting unit. The visualization display unit converts the acquired data into a JSON object for front-end drawing. The visualization display unit includes a dynamic rendering engine operating on a web browser. The visualization display unit inputs the JSON object to the dynamic rendering engine. The dynamic rendering engine executes coordinate calculation and color space mapping of data points. The dynamic rendering engine generates an interactive graphical user interface element as output data. The output data includes, for example, SVG data of a line graph indicating a change in evaluation score with respect to a time axis, canvas data of a two-dimensional heat map indicating the level of the overall contribution degree by color shading, vertex coordinate data of a radar chart indicating multidimensional evaluation items by a polygon, and the like. The visualization display unit monitors an input event such as a click or a scroll from a user. The visualization display unit executes a drill-down process of dynamically changing the granularity of data to be displayed in accordance with the input event. With this configuration, the system converts complex multidimensional data into intuitively understandable visual information. The system optimizes a drawing load of a client terminal and renders a large number of data points without delay. The system brings about technical effects of improving the decision-making speed of the administrator and improving the efficiency of data exploration. This is because the system separates data aggregation on the server side and asynchronous drawing on the client side, and provides an interactive data exploration environment that immediately responds to a user operation. The present technology is applicable to use cases such as a management dashboard system and an operation status monitoring system of factory equipment. The system also includes a variation provided with a personalization function of learning line-of-sight movement data and an operation history of the user and automatically arranging the most frequently referred graph at the top of the dashboard. The system is an improvement in computer-specific user interface technology of visual mapping and dynamic reconfiguration of multidimensional data, rather than a mere enumeration of information.

The reward design unit performs multivariate analysis on the overall contribution degree, the past commendation history, the motivation tendency of the employee, the on-site reward policy, the budget status, the career orientation, the past incentive response, and the like using the generative AI, and automatically designs an optimal reward and commendation plan according to the on-site and individual orientation, such as “special commendation+monetary reward”, “selection as an on-site improvement project leader”, “a right to participate in joint development with a robot maker”, and “granting of skill certification points”. Specific examples of a prompt sentence to be read by the generative AI include “Design an optimal reward and commendation plan in consideration of the overall contribution degree, past commendation history, motivation tendency, and on-site reward policy of employee X. Explain the proposal content together with a basis.”, and the like. Specifically, the reward design unit acquires the overall contribution degree score from the work performance integration unit, and acquires profile data of the employee from a human resource database. The reward design unit combines the acquired data to generate an employee state vector. The employee state vector includes, for example, a normalized numerical value indicating the overall contribution degree, a balance numerical value indicating the budget status, an encoding array of a categorical variable indicating the past incentive response, and the like. The reward design unit holds a reward optimization agent based on a deep reinforcement learning algorithm. The reward design unit inputs the employee state vector to the reward optimization agent. The reward optimization agent calculates an optimal action value using a current policy network based on a Markov decision process model. The reward optimization agent outputs an array of action value Q values for a plurality of reward plans as output data. The output data is, for example, numerical data such as a Q value of 0.88 for a combination of a special commendation and a monetary reward, a Q value of 0.95 for selection as a project leader, and a Q value of 0.72 for a right to participate in joint development. The reward design unit selects a reward plan having the maximum Q value. The reward design unit inputs an identifier of the selected reward plan to a large language model. The large language model generates a natural language text explaining the validity of the selected reward plan. The reward design unit transmits the generated text and the identifier of the reward plan to a subsequent approval system. With this configuration, the system solves a resource allocation problem of maximizing the motivation of the entire organization within a limited budget constraint. The system automates a process of reward design and reduces a work load of the administrator. The system brings about a technical effect of optimizing the return on investment of incentives. This is because the system continuously updates a reinforcement learning model using a past reward granting history and a subsequent performance change as a reward signal, and dynamically searches for a reward most suitable for individual characteristics. The present technology is applicable to use cases such as an incentive calculation system of a sales department and a task reward dynamic setting system in a freelance platform. The system also includes a variation of presenting a random reward plan with a certain probability using an epsilon-greedy method to adjust a trade-off between exploration and exploitation, thereby improving generalization performance of the model. The system replaces work relying on human intuition with computer technology of solving an optimization problem in a high-dimensional state space.

The feedback generation unit automatically generates a specific improvement proposal and an action plan based on the evaluation result by the AI, such as “The feasibility of the operation pattern optimization plan will increase by analyzing the on-site sensor data in more detail”, “It is recommended to implement an additional risk assessment to strengthen the safety evaluation”, “Collecting additional learning data is effective for improving the accuracy of the anomaly detection algorithm”, and “The effect of the energy-saving operation proposal is maximized by linking it with the on-site operation schedule”, and distributes them to the worker and the engineer. Specific examples of a prompt sentence to be read by the generative AI include “Generate a specific improvement proposal and a future action plan for the employee based on the following evaluation result. Evaluation result: innovativeness 8points, feasibility 7 points, productivity/quality impact 9 points, safety 8 points.”, and the like. Specifically, the feedback generation unit acquires the score of each viewpoint and the extracted problem text from the automatic evaluation index calculation unit. The feedback generation unit formats the acquired data into an input prompt character string. The input prompt character string includes, for example, a numerical value of an innovativeness score of 8 points, a numerical value of a feasibility score of 7 points, and a problem flag indicating a lack of sensor data analysis. The feedback generation unit holds a fine-tuned generative transformer model. The feedback generation unit inputs the input prompt character string to the generative transformer model. The generative transformer model analyzes a dependency relationship between input tokens using a self-attention mechanism. The generative transformer model autoregressively generates a text sequence of the improvement proposal as output data. The output data includes, for example, a text indicating a detailed analysis procedure of sensor data, a text indicating a checklist for an additional risk assessment, a text indicating a template of an automated script for learning data collection, and the like. The feedback generation unit inputs the generated text sequence to a natural language processing filter, and verifies whether an inappropriate expression or content violating internal regulations is included. The feedback generation unit transmits the text data that has passed the verification to a messaging server. The messaging server asynchronously distributes a message to a terminal of the target worker or engineer. With this configuration, the system immediately provides constructive feedback on the evaluation result. The system speeds up a brush-up cycle of the proposal. The system brings about a technical effect of continuously improving the quality of ideas. This is because the system does not stop at merely notifying the score, but generates a specific next action using a model that has learned history data of how past similar proposals were improved and adopted. The present technology is applicable to use cases such as an automatic report correction system for students and an automatic code correction proposal system for programmers. The system also includes a variation provided with a parameter control function of dynamically adjusting the length of the generated feedback text according to the job title and technical level of the recipient. The system is an improvement in computer technology that utilizes the inference capability of a large language model to improve the efficiency and accuracy of information transmission, rather than substituting human instruction work.

The progress reporting unit analyzes the evaluation status of the proposal, the progress of on-site introduction, and the prediction of a business impact by the AI, and distributes a quantitative progress and effect prediction as a report to the related party, such as “The operation optimization proposal is currently in an on-site test stage, and an initial evaluation expects a 10% improvement in picking work efficiency and a 30% reduction in safety incident occurrence rate” and “Additional consideration is necessary because a linkage problem with the existing on-site control system remains”. Specific examples of a prompt sentence to be read by the generative AI include “Predict a future business impact based on the progress status and evaluation history of the following idea, and generate a progress report for related parties.”, and the like. Specifically, the progress reporting unit acquires a task completion status from a project management database, and acquires real-time operation metrics from an on-site IoT gateway. The progress reporting unit integrates the acquired data to construct a progress state tensor. The progress state tensor includes, for example, a categorical value indicating the on-site test stage, a floating-point number indicating a current value of the picking work efficiency, a time-series array indicating a transition of the safety incident occurrence rate, and the like. The progress reporting unit holds a multi-task learning model integrating a recurrent neural network for time-series prediction and a language model for text generation. The progress reporting unit inputs the progress state tensor to the multi-task learning model. The multi-task learning model simultaneously executes future metrics prediction and report text generation while sharing a representation of a hidden layer. The multi-task learning model outputs an array of predicted numerical values and a natural language report text as output data. The output data includes, for example, a predicted numerical value of a 10 percent improvement in work efficiency, a predicted numerical value of a 30 percent reduction in incidents, and a text pointing out the existence of a system linkage problem. The progress reporting unit converts the output report text into a document in a PDF or HTML format. The progress reporting unit automatically transmits the generated document to an email address of the related party. With this configuration, the system automatically documents the progress status and future prediction of the project. The system reduces human man-hours required for creating a report to zero. The system brings about technical effects of improving transparency of project management and early detection of risks. This is because the system integrally analyzes real-time sensor data and task progress data, and a neural network detects and reports signs of minute delays and performance degradation that are difficult to notice by human intuition. The present technology is applicable to use cases such as an agile development management system for software development and a process management system for a construction site. The system also includes a variation of setting an alert flag and transmitting an emergency notification to a terminal of the administrator when the predicted business impact falls below a preset target value. The system executes advanced computer processing of integrated analysis of multimodal data and prediction calculation of a future state, rather than mere data format conversion.

In this way, by fusing the knowledge of on-site employees and engineers with on-site data, and realizing multifaceted automatic evaluation, integration, reward design, feedback, and progress management by the generative AI in an integrated manner, the system can efficiently and fairly promote on-site-led innovation and continuous improvement of productivity, quality, and safety in the factory robot field. Specifically, the system adopts a distributed processing architecture in which a plurality of independent neural network modules are coupled by an asynchronous message queuing protocol. The system seamlessly passes high-dimensional tensor data and metadata between the modules. The system completely automates and executes a series of data pipelines from vectorization of multimodal data in an input layer to generation of an optimized reward plan and feedback text in an output layer. The system persists intermediate data generated in each processing step in a graph database. The system utilizes this graph database as a knowledge graph to continuously improve the accuracy of subsequent inference tasks. The system offloads a part of inference processing to an edge computing device in order to minimize processing latency of the entire system. With this configuration, the system integrates a vast amount of on-site data and human tacit knowledge in a digital space. The system algorithmizes the innovation creation process itself and executes it in a scalable manner. The system brings about technical effects of accelerating a knowledge creation cycle of the entire organization and establishing a sustainable competitive advantage. This is because the system not only automates individual tasks, but also constructs a series of processes of evaluation, integration, reward design, and feedback as a closed-loop machine learning system, and includes a mechanism in which the entire system evolves in a self-organizing manner. The present technology is applicable not only to the manufacturing industry but also to use cases in all industrial fields, such as a business improvement system in a medical institution, a store operation optimization system in a retail business, and a new service development platform in a financial institution. The system also includes a variation in which the inference model of each module is subjected to distributed learning using federated learning, and the model is shared among a plurality of bases while protecting privacy. The system goes beyond a mere tool for supporting human intellectual activities, functions as a data-driven autonomous knowledge processing engine, and provides a fundamental improvement in computer technology.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

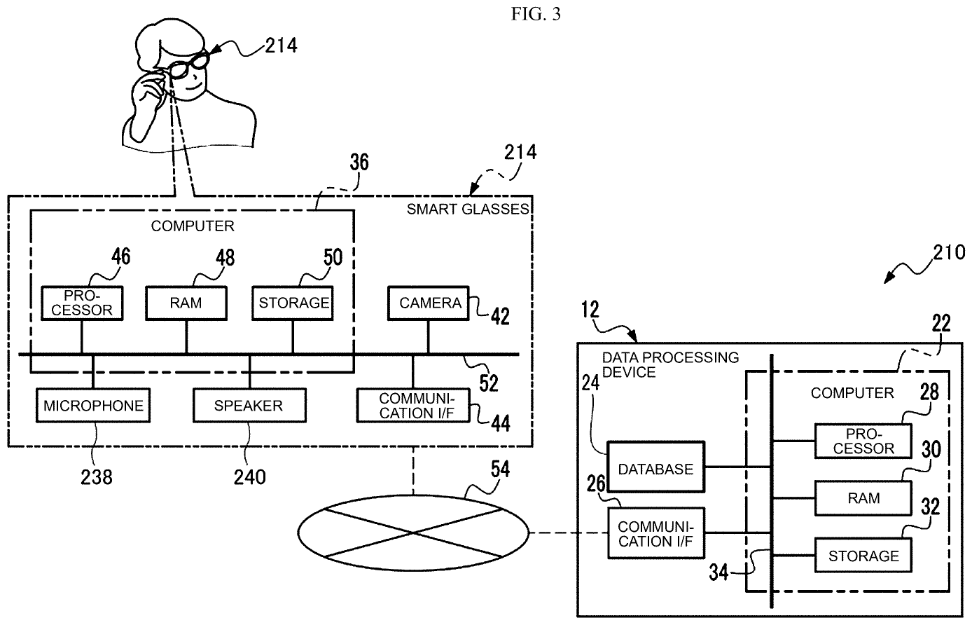

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

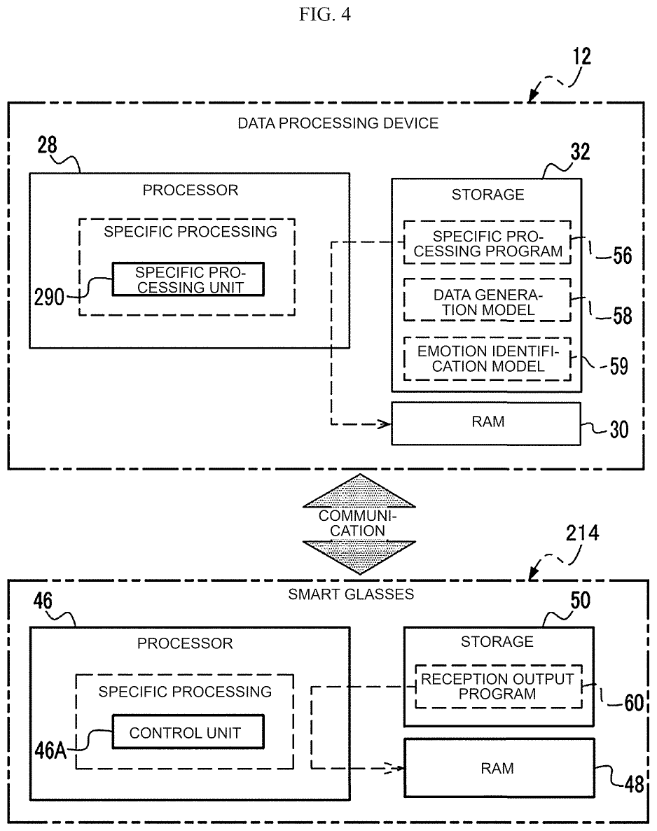

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

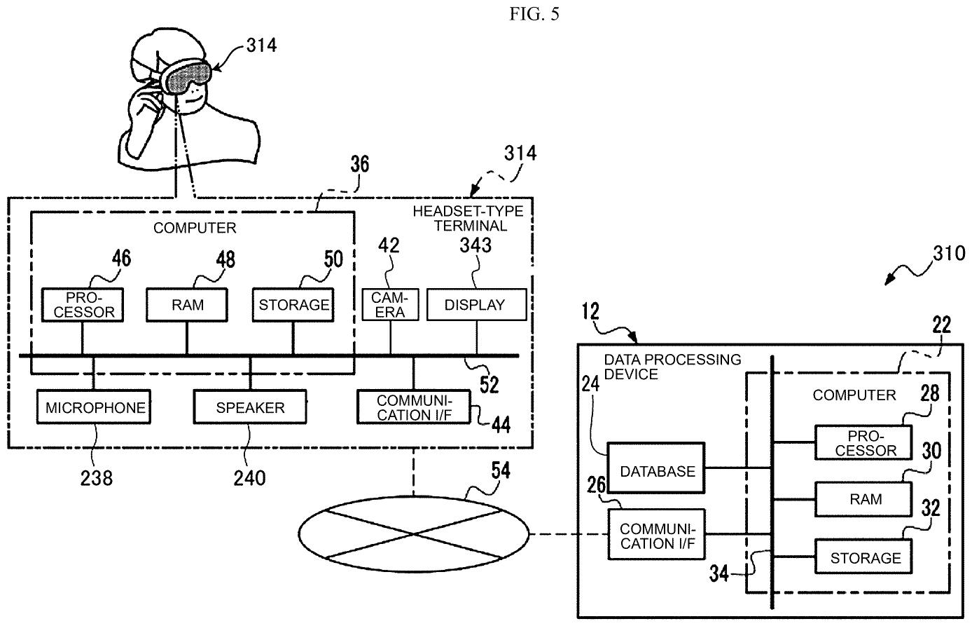

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

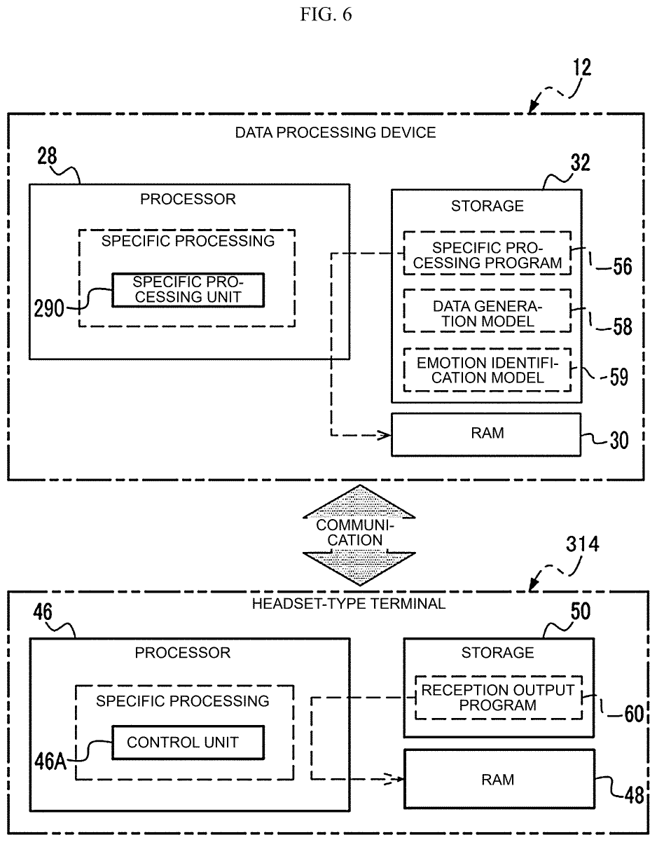

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

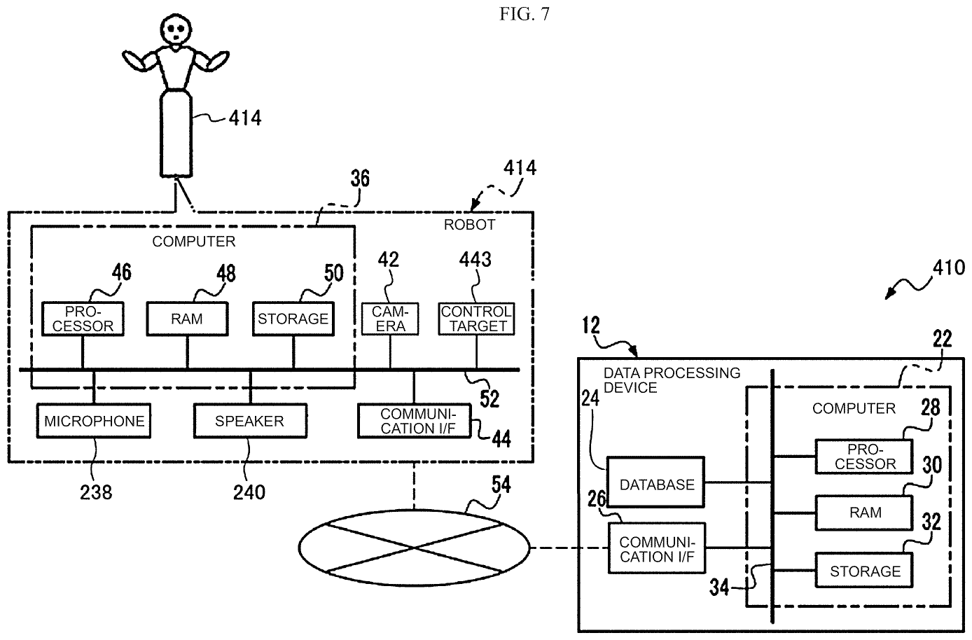

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

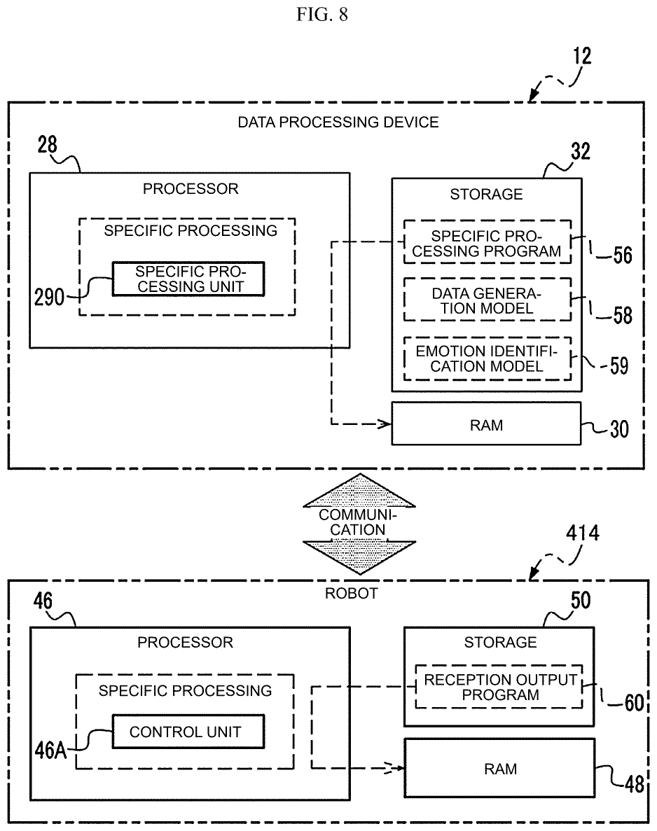

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

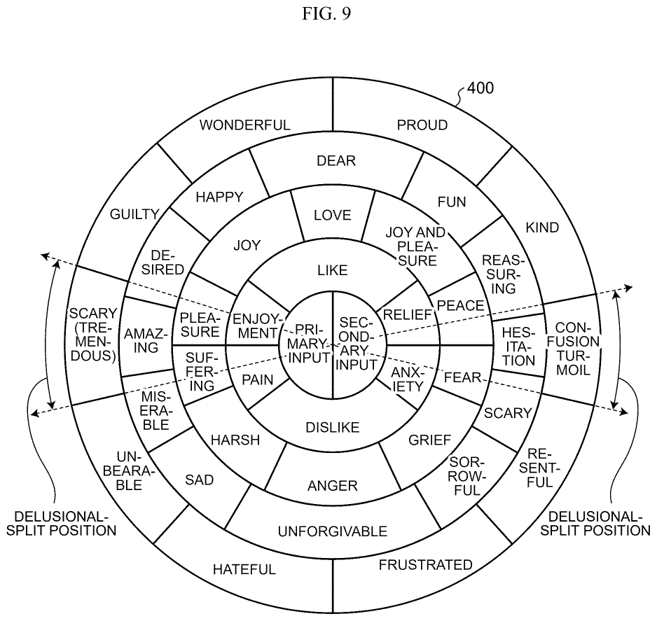

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

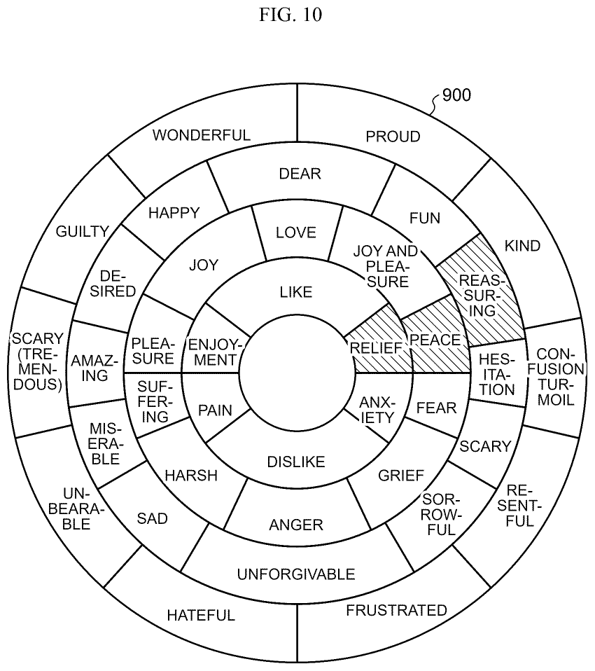

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A system for evaluating and managing a new proposal and an improvement idea from an on-site employee and an engineer in a factory robot field, comprising: an idea receiving unit; an automatic evaluation index calculation unit; a work performance integration unit; a visualization display unit; a reward design unit; a feedback generation unit; and a progress reporting unit, wherein the idea receiving unit is configured to receive a title, a detailed explanation, a related material, a sensor log, a work video, an on-site drawing, submitter information, a submission date and time, a related project name, an expected effect, and the like of an idea regarding robot operation and improvement input from a terminal by the on-site employee and the engineer, and record them in a database on a server side; the automatic evaluation index calculation unit is configured to collate content and attached data of the received idea with natural language processing, knowledge base collation, a past similar case, a technology trend, patent information, an academic paper, on-site data, and the like using generative AI, thereby automatically calculating each evaluation index of innovativeness, feasibility, productivity/quality impact, and safety; the work performance integration unit is configured to automatically collect performance data such as a productivity index, a quality control score, a safety compliance rate, a commendation history, and a skill-up training attendance history of the on-site employee and the engineer, and integrate the performance data with the evaluation indices to calculate an overall contribution degree; the visualization display unit is configured to display the evaluation indices and the overall contribution degree on a dashboard in various formats such as a graph, a heat map, a radar chart, and a progress Gantt chart; the reward design unit is configured to analyze the overall contribution degree, a past commendation history, a motivation tendency, an on-site reward policy, a budget status, a career orientation, and the like using the generative AI, and automatically design an optimal reward and commendation plan according to an on-site and individual orientation; the feedback generation unit is configured to automatically generate an evaluation result, an improvement proposal, and a specific action plan using the generative AI, and distribute them to the employee and the engineer; and the progress reporting unit is configured to analyze an evaluation status of the proposal, progress of on-site introduction, and a prediction of a business impact using the generative AI, and distribute a quantitative progress and effect prediction as a report to a related party.

### Supplementary Note 2

The system according to Supplementary Note 1, wherein the automatic evaluation index calculation unit is configured to analyze an explanatory text of the submitted robot operation and improvement proposal, the attached sensor log, work video, on-site drawing, and the like using the generative AI, combine natural language processing, image analysis, and time-series data analysis to score each evaluation index of innovativeness, feasibility, productivity/quality impact, and safety on a 10-point scale, automatically generate a basis for each viewpoint, further collate them with a past similar proposal, an industry technology trend, patent information, and on-site operation record data to calculate a total evaluation score, and display the total evaluation score on the dashboard in a visual format together with the evaluation basis.

### Supplementary Note 3

The system according to Supplementary Note 1, wherein the reward design unit is configured to perform multivariate analysis on the overall contribution degree, the past commendation history, the motivation tendency of the employee and the engineer, the on-site reward policy, the budget status, the career orientation, a past incentive response, and the like using the generative AI, and optimize and automatically design various reward and commendation plans such as a special commendation, a monetary reward, selection as an on-site improvement project leader, a right to participate in joint development with a robot maker, and granting of skill certification points for each employee and engineer; further, the feedback generation unit is configured to automatically generate the evaluation result, the improvement proposal, and a specific action plan for on-site introduction using the generative AI; and the progress reporting unit is configured to analyze the evaluation status of the proposal, the progress of on-site introduction, and the prediction of a business impact using the generative AI, and automatically distribute a report including a quantitative progress and effect prediction to the related party.

What is claimed is:

1. A system comprising:
circuitry configured to:
receive, via a communication interface coupled to a packet-switched network, submission data records from a terminal device, each submission data record comprising text data, multimedia data comprising video frame sequences and time-series sensor log data, and structured attribute data, and store the submission data records in a storage device;
apply a three-dimensional convolutional neural network to the video frame sequences to extract spatiotemporal feature vectors, and apply a fast Fourier transform to the time-series sensor log data to generate frequency domain feature data;
apply a multimodal neural network comprising a cross-attention mechanism to fuse text embedding vectors generated from the text data with the spatiotemporal feature vectors and the frequency domain feature data to generate a representation tensor associating physical state data with textual content;
apply a generative neural network model to the representation tensor and knowledge base records retrieved from a vector database to compute evaluation dimension scores across a plurality of evaluation criteria and an aggregate contribution score;
generate feedback text data and recommendation data from the evaluation dimension scores and the aggregate contribution score using the generative neural network model; and
transmit the evaluation dimension scores, the aggregate contribution score, the feedback text data, and the recommendation data to the terminal device via the communication interface.

2. The system according to claim 1, wherein the circuitry is configured to execute primary processing of the multimedia data at an edge computing node proximate to the terminal device by applying a high-frequency noise filter to vibration and temperature time-series data and extracting a compact feature vector, and transmit the compact feature vector to a cloud computing node via the communication interface for integration with text data in the multimodal neural network.

3. The system according to claim 2, wherein the circuitry is configured to input the compact feature vector and a text embedding vector of the text data to the multimodal neural network, apply the cross-attention mechanism to compute cross-modal attention weights between text token positions and feature vector dimensions, and generate the representation tensor by weighted aggregation of the cross-modal attention outputs.

4. The system according to claim 3, wherein the circuitry is configured to apply a three-dimensional convolutional neural network to video frame sequences divided at a predetermined frame rate to extract a 512-dimensional spatiotemporal feature vector representing movement patterns in the video data, and concatenate the spatiotemporal feature vector with the compact feature vector prior to input to the multimodal neural network.

5. The system according to claim 1, wherein the circuitry is configured to retrieve knowledge base records from the vector database by computing cosine similarity scores between a query embedding vector derived from the text data and stored knowledge base record embedding vectors, and select knowledge base records having cosine similarity scores exceeding a retrieval threshold parameter for inclusion in a retrieval-augmented generation prompt.

6. The system according to claim 5, wherein the circuitry is configured to compute the evaluation dimension scores by applying the generative neural network model to a retrieval-augmented generation prompt comprising the representation tensor, the retrieved knowledge base records, and a standardization parameter set, the evaluation dimension scores comprising a first dimension score, a second dimension score, and a third dimension score, and compute the aggregate contribution score as a weighted sum of the evaluation dimension scores.

7. The system according to claim 6, wherein the circuitry is configured to retrieve historical submission data records from the storage device having aggregate contribution scores within a predetermined range of the computed aggregate contribution score, compute a similarity ranking of the retrieved historical submission data records based on embedding vector cosine similarity, and incorporate ranked historical submission data records as additional context in the retrieval-augmented generation prompt.

8. The system according to claim 1, wherein the circuitry is configured to receive contribution record data associated with a submitter identifier from an external data service via the communication interface, integrate the contribution record data with the evaluation dimension scores to compute an overall contribution score, and store the overall contribution score associated with the submitter identifier in the storage device.

9. The system according to claim 8, wherein the circuitry is configured to generate the recommendation data by applying the generative neural network model to the overall contribution score, historical contribution record data associated with the submitter identifier, and a preference profile record stored in the storage device, and personalize the recommendation data based on the preference profile record.

10. The system according to claim 1, wherein the circuitry is configured to receive version update data for a previously submitted submission data record from the terminal device via the communication interface, apply the three-dimensional convolutional neural network and the multimodal neural network to the updated multimedia data and text data to generate an updated representation tensor, and recompute the evaluation dimension scores and aggregate contribution score from the updated representation tensor.

11. The system according to claim 1, wherein the circuitry is configured to detect a submission data record having a text data field semantically similar to a previously stored submission data record by computing cosine similarity between text embedding vectors, generate a duplicate notification data record when a cosine similarity score exceeds a duplicate threshold parameter, and transmit the duplicate notification data record to the terminal device prior to storing the incoming submission data record.

12. The system according to claim 1, wherein the circuitry is configured to apply a natural language processing model to the text data of each submission data record to automatically generate classification tag data comprising topic identifiers and domain category labels, and associate the classification tag data with the submission data record in the storage device.

13. The system according to claim 12, wherein the circuitry is configured to generate visualization output data from the evaluation dimension scores and aggregate contribution scores stored in the storage device, the visualization output data comprising graph data representing score distributions across classification tag categories over a time series, and transmit the visualization output data to the terminal device for dashboard display.

14. The system according to claim 1, wherein the circuitry is configured to generate progress report data by applying the generative neural network model to the evaluation dimension scores, the aggregate contribution score, and historical evaluation data associated with the submission data record retrieved from the storage device, and transmit the progress report data to recipient terminal devices identified in a distribution list associated with the submission data record.

15. The system according to claim 1, wherein the circuitry is configured to update the generative neural network model by generating training pairs from historical evaluation dimension scores and corresponding validated outcome data, and fine-tune the generative neural network model on the training pairs to improve evaluation accuracy for specific domain category patterns.

16. The system according to claim 1, wherein the circuitry is configured to apply multilingual translation processing to the text data of received submission data records using a neural machine translation model, generate translated text data in a target language specified by a locale parameter, and incorporate the translated text data into the text embedding vector generation pipeline.

17. The system according to claim 1, wherein the multimedia data comprises on-site operation video data and sensor log data from automated equipment, the text data comprises improvement proposal descriptions submitted by equipment operators, and the evaluation dimension scores correspond to technical feasibility, operational impact, and implementation complexity.

18. A system comprising:
circuitry configured to:
receive, via a communication interface coupled to a packet-switched network, submission data records comprising text data, video frame sequences, and time-series sensor log data from a terminal device;
apply a three-dimensional convolutional neural network to the video frame sequences to generate a spatiotemporal feature vector, and apply a fast Fourier transform to the time-series sensor log data to generate frequency domain feature data;
apply a multimodal neural network comprising a cross-attention mechanism to fuse a text embedding vector generated from the text data with the spatiotemporal feature vector and the frequency domain feature data to generate a representation tensor;
apply a generative neural network model to the representation tensor and knowledge base records retrieved by cosine similarity search from a vector database to compute evaluation dimension scores and an aggregate contribution score; and
transmit the evaluation dimension scores, the aggregate contribution score, feedback text data, and recommendation data generated from the evaluation dimension scores to the terminal device via the communication interface.

19. The system according to claim 18, wherein the circuitry is configured to retrieve historical submission data records from the storage device having aggregate contribution scores within a range of the computed aggregate contribution score, incorporate ranked historical submission data records as additional context in a retrieval-augmented generation prompt, and generate personalized recommendation data conditioned on a preference profile record associated with a submitter identifier.

20. A method comprising:
receiving, via a communication interface coupled to a packet-switched network, submission data records from a terminal device, each submission data record comprising text data, multimedia data comprising video frame sequences and time-series sensor log data, and structured attribute data, and storing the submission data records in a storage device;
applying a three-dimensional convolutional neural network to the video frame sequences to extract spatiotemporal feature vectors, and applying a fast Fourier transform to the time-series sensor log data to generate frequency domain feature data;
applying a multimodal neural network comprising a cross-attention mechanism to fuse text embedding vectors generated from the text data with the spatiotemporal feature vectors and the frequency domain feature data to generate a representation tensor;
applying a generative neural network model to the representation tensor and knowledge base records retrieved from a vector database to compute evaluation dimension scores across a plurality of evaluation criteria and an aggregate contribution score;
generating feedback text data and recommendation data from the evaluation dimension scores and the aggregate contribution score using the generative neural network model; and
transmitting the evaluation dimension scores, the aggregate contribution score, the feedback text data, and the recommendation data to the terminal device via the communication interface.
